(19) United States
(12) Patent Application Publication
(10) Pub. No.: US 2026/0203299 A1
(43) Pub. Date: Jul. 16, 2026

(54) Multi-Functional Dashboard User Interface System and Method

(71) Applicant: Newtek Business Services Corp., Boca Raton (FL)

(72) Inventors: Barnet Neff, Boca Raton, FL (US); Dan Hendel, Boca Raton, FL (US); Jim Corcoran, Boca Raton, FL (US)

(21) Appl. No.: 19/566,967

(22) Filed: Mar. 13, 2026

Related U.S. Application Data
(63) Continuation of application No. 18/107,562, filed on Feb. 9, 2023, now abandoned.
(60) Provisional application No. 63/315,629, filed on Mar. 2, 2022.

(51) Int. Cl. G06F 16/26; G06F 3/0482; G06F 9/451

(52) U.S. Cl. CPC G06F 16/26; G06F 3/0482; G06F 9/451

(57) ABSTRACT

A system and method employing a versatile and dynamically adjustable multi-functional dashboard user interface are disclosed. In some implementations having utility in enterprise management applications, the disclosed dashboard user interface provides key or predetermined indicators related to the performance of a commercial enterprise across various business functions such as finance, human resources, marketing, and the like. The disclosed system and method may connect with disparate data sources and make those data available via a single login and single view (i.e., multi-functional dashboard user interface).

### CROSS-REFERENCE TO RELATED APPLICATIONS

This application is a continuation of U.S. Patent Application Ser. No. 18/107,562, filed Feb. 9, 2023, which claims the benefit of U.S. Provisional Patent Application No. 63/315,629, filed Mar. 2, 2022, the disclosures of each of which are hereby incorporated by reference herein.

### FIELD OF THE DISCLOSURE

Aspects of the disclosed subject matter relate generally to user interface methodologies, and more particularly to a system and method employing a versatile and dynamically adjustable multi-functional dashboard user interface.

### BACKGROUND

In the digital economy, business owners use a variety of online services, each of which typically is associated with its own stream of data. Conventionally, there is no automated way for a business owner or enterprise software package to capture all the data streams from a variety of independent data sources and funnel those data into a single repository. It is time prohibitive for a business owner to consolidate the data manually, and as a result, the value of accessing the disparate information together remains locked.

In a typical implementation, a user wishing to access a first data stream from a first source must use a first interface dedicated to that stream; such an interface may be in the form of a proprietary interface, software package, or “app,” for instance, or it may be a dedicated or independent window or tab in a generic browser-type application such as may be configured and operative to decode hypertext markup language for display. If that same user were attempting to access a second data stream from a second source, however, a second interface dedicated to that stream would be required. This requires switching between tabs or windows in a familiar browser, or toggling between separate apps or proprietary interfaces. Moreover, since the interfaces are not integrated, allowing a first functional block or module to access data from a second source typically involves export of data from one interface to be received by a different, independent one; this includes processing overhead and exposes the data to interception, corruption, or loss.

Aspects of the disclosed subject matter address the foregoing shortcomings of conventional user interface paradigms and other associated data management hassles by providing a dashboard user interface having components which are capable of connecting with disparate data sources and making the data available in a single login and single view.

### SUMMARY OF THE DISCLOSURE

The following presents a simplified summary of the disclosure in order to provide a basic understanding of some aspects of various embodiments disclosed herein. This summary is not an extensive overview of the disclosure. It is intended neither to identify key or critical elements of the disclosed embodiments nor to delineate the scope of those embodiments. Its sole purpose is to present some concepts of the disclosed subject matter in a simplified form as a prelude to the more detailed description that is presented later.

The present disclosure describes a system and method employing a user interface that is capable of providing key indicators about the performance of a commercial enterprise across its several business functions. In particular, the NewtekOne™ dashboard was illustrated and described in connection with U.S. provisional patent application Ser. No. 63/315,629, filed Mar. 2, 2022 (from which priority is claimed), and is representative of early work in this space conducted by Newtek® Business Services Corp. A commercial embodiment, the NewtekAdvantage™, is another example of a multi-functional dashboard user interface that is both versatile and dynamically adjustable.

In that regard, a multi-functional dashboard user interface (or simply “dashboard”) as illustrated and described herein may provide business owners (as well as administrators, information technology professionals, and other interested parties) with a single view of business performance, metrics, or other data across (among other business units or functions) finance, people or human resources, and marketing operations. This approach to aggregation of disparate functionalities allows a user of the dashboard to track, monitor, and take action on data (via convenient interaction with a single dashboard) that were previously only available via interacting with a different respective interface dedicated to a respective, separate system.

In accordance with one aspect of the disclosed subject matter, a method of displaying and updating records using a multi-functional dashboard user interface may generally comprise: retrieving internal data from an internal data source; retrieving external data from an external data source; responsive to the retrieving internal data and the retrieving external data, processing the retrieved data by applying an instruction set selectively to process the internal data and the external data in accordance with the internal data source and the external data source, respectively; displaying a result of the processing in a dashboard user interface; and selectively instructing one of the internal data source or the external data source to update a data record responsive to the processing and, optionally, responsive to input from a user.

Methods are disclosed wherein the internal data source is maintained on an enterprise resource. In some implementations, the retrieving internal data comprises using an internal data source application programming interface, the retrieving external data comprises using an external data source application programming interface, or both.

Methods are disclosed wherein the external data source is maintained by an independent third party.

In some implementations, the displaying comprises transmitting the dashboard user interface to a display associated with a user device; additionally or alternatively, the displaying comprises transmitting data associated with the dashboard user interface to a display associated with a user device.

Methods are disclosed wherein the selectively instructing comprises causing an independent system associated with the internal data source or the external data source to alter the data record based upon the user's interaction with the dashboard user interface.

In accordance with another aspect of the disclosed subject matter, a multi-functional dashboard user interface system may generally comprise: a first data source processing module to receive first data from a first data source; a second data source processing module to receive second data from a second data source; and a processing resource configured and operative in connection with the first data source processing module and the second data source processing module to: apply an instruction set selectively to process the first data and the second data in accordance with the first data source and the second data source, respectively; provide an output to a display for displaying a dashboard user interface; and selectively instruct one of the first data source or the second data source to update a data record responsive to the output and, optionally, responsive to input from a user.

Systems are disclosed wherein the first data source is an internal data source and wherein the second data source is an external data source. In some implementations, the processing resource comprises a central processing unit.

In some systems, the first data source processing module receives the first data via a first application programming interface and the second data source processing module receives the second data via a second application programming interface.

Systems are also disclosed wherein the first data source processing module comprises hardware components and software components and the second data source processing module comprises hardware components and software components.

The foregoing and other aspects of various disclosed embodiments will be apparent through examination of the following detailed description thereof in conjunction with the accompanying drawing figures, in which like reference numerals are used to represent like components throughout, unless otherwise noted.

### DESCRIPTION OF THE DRAWING FIGURES

FIG. 1 is a view of one embodiment of a multi-functional dashboard user interface;

FIG. 2 is a view of one embodiment of a multi-functional dashboard user interface displayed in connection with use of a portable device;

FIG. 3 is a block diagram of a system enabling a multi-functional dashboard user interface;

FIG. 4 is a block diagram of a distributed environment supporting a system employing a multi-functional dashboard user interface;

FIG. 5 is a view of one embodiment of a multi-functional dashboard user interface, such as that shown in FIG. 1, having connected accounts and customizable information displays;

FIGS. 6 through 16 illustrate aspects of certain functional components of the multi-functional dashboard user interface of FIG. 5;

FIG. 17 is a view of one embodiment of a multi-functional dashboard user interface, such as that shown in FIG. 5, having customizable information displays, but no connected accounts; and

FIG. 18 is a functional flow diagram illustrating aspects of one implementation of a method of displaying and updating records using a multi-functional dashboard user interface.

### DETAILED DESCRIPTION

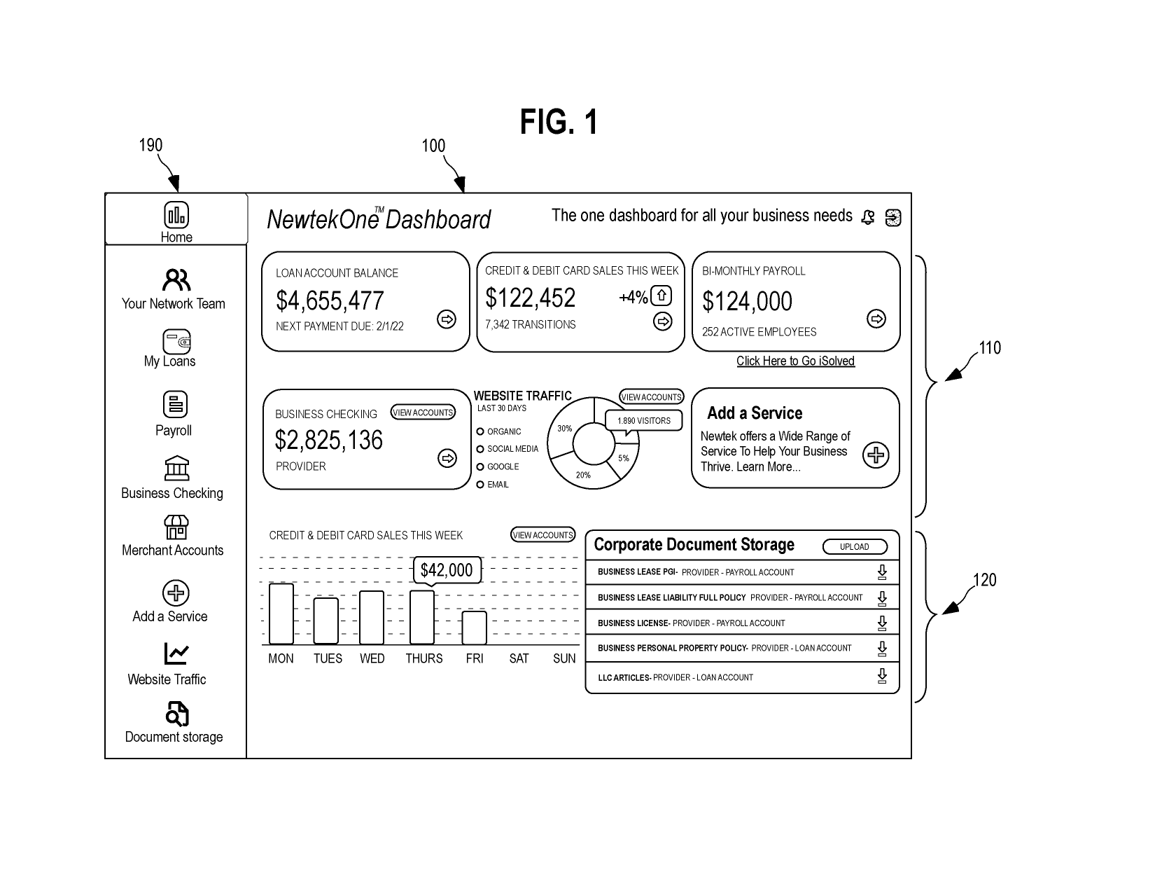

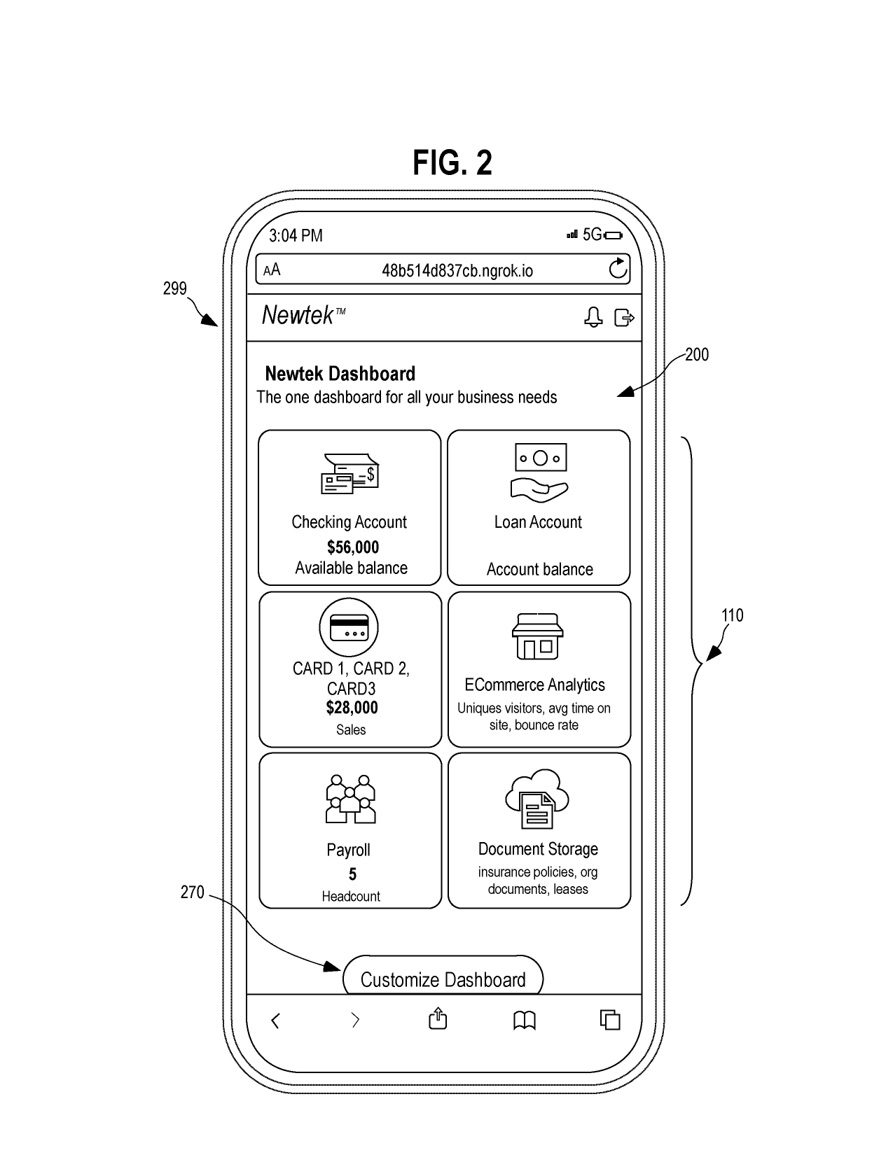

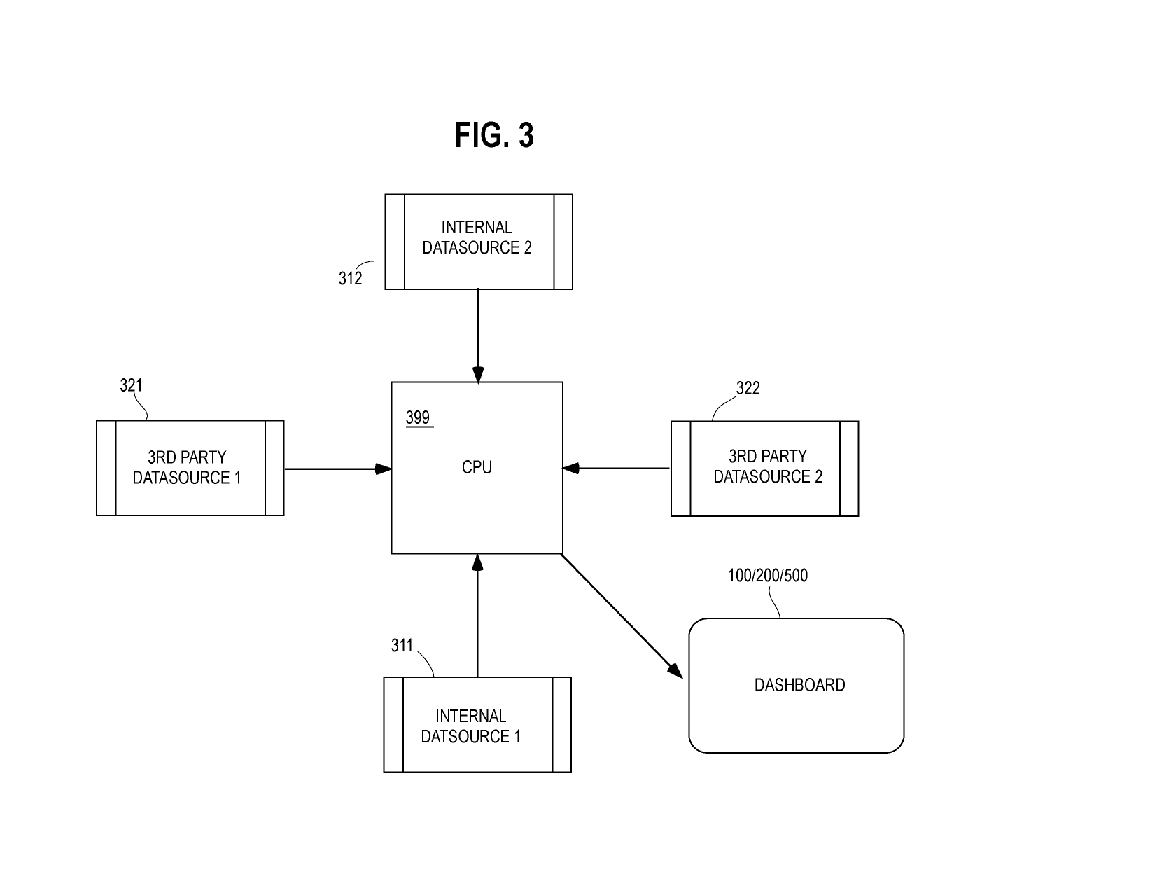

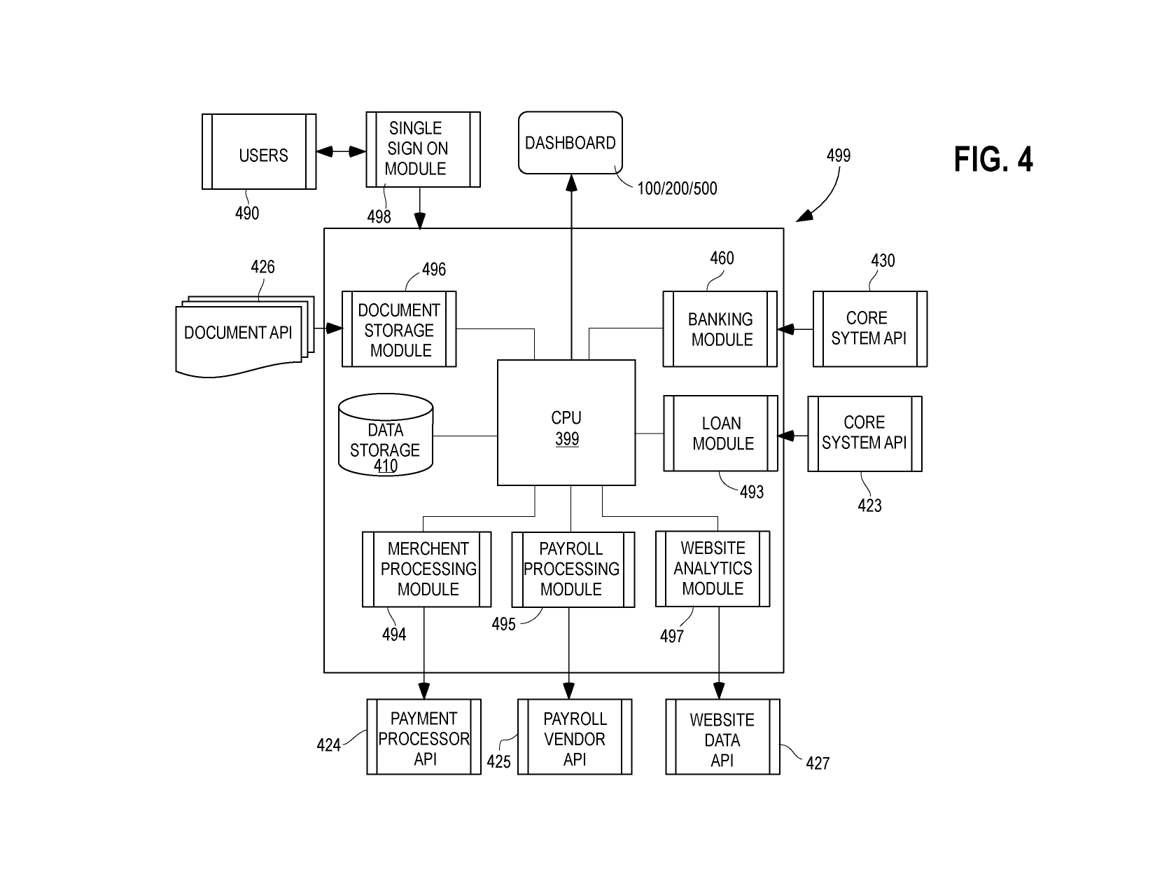

Most financial institutions face the challenge of servicing customers across a wide spectrum of business services. A key component of this challenge is connecting the disparate data sources that underlie those services (see, e.g., FIGS. 3 and 4) and presenting an holistic view to the customers (see, e.g., FIGS. 1 and 2). In a departure from conventional data processing and user interface paradigms, a multi-functional and programmable dashboard (reference numeral 100) addresses the foregoing and other challenges associated with modern enterprise management in a “Big Data” context.

Turning now to the drawing figures, FIG. 1 is a view of one embodiment of a multi-functional dashboard user interface; FIG. 2 is a view of one embodiment of a multi-functional dashboard user interface displayed in connection with use of a portable device; FIG. 3 is a block diagram of a system enabling a multi-functional dashboard user interface; and FIG. 4 is a block diagram of a distributed environment supporting a system employing a multi-functional dashboard user interface. In particular, all of these drawing figures depict a versatile and dynamically adjustable (i.e., selectively modifiable or programmable) multi-functional dashboard user interface (such as dashboard 100) in varying levels of detail.

As indicated in FIGS. 1 and 2, dashboards 100 and 200 may generally comprise a number of discrete user interface mechanisms allowing access to diverse and varied functionality. In FIG. 1, these interface mechanisms are generally represented by reference numerals 110 and 120, but may also include a menu or selection area (depicted at reference numeral 190) having representative icons or thumbnails which may also allow selection of or navigation to particular functionality via a mouse “click,” touch screen “tap,” or other familiar graphical user interface selection mechanism. Dashboard 100 is illustrated as generally having a first field or “zone” for interface mechanisms 110, and a second or ancillary zone for interface mechanisms 120. As depicted in FIG. 1, the first zone is on the top of the display screen, whereas the second zone is depicted beneath, but this may be selectively changed to suit preferences; these zones are only contemplated to assist a particular user of the customizable dashboard 100 to cluster or orient related, similar, or equally important interface mechanisms in a logical layout that makes interaction with dashboard 100 functionalities efficient for that particular user. For instance, for a “human resources” professional, all of the “human resources” and payroll related interface mechanisms 110 may be clustered together in the first zone (or the second), while infrequently accessed interface mechanisms 120 may be clustered together in the second zone. Such clustering may be differently motivated for a “marketing” professional, who may want sales projections, website traffic data, and marketing pitch materials clustered together, while relegating human resources related materials to a less prominent location in the display screen. A customization feature may be accessed via a selection option (see reference numeral 270 in FIG. 2) or a “preferences” or “settings” menu item (not shown in FIG. 1) to allow for interface mechanisms 110/120 to be moved, grouped, hidden, enlarged, etc. as desired.

In FIG. 2, dashboard 200 is illustrated as executing on a portable or handheld device 299, such as a wireless telephone, tablet computer, personal digital assistant, or the like. In a typical embodiment, device 299 has a display area that is smaller than that of a typical display screen for use in connection with desktop computers or workstations, and so dashboard 200 may be simplified as compared to dashboard 100, as is typical for portable or wireless applications. Accordingly, to optimize use of the display screen of device 299, dashboard 200 is illustrated as only having one field or zone for interface mechanisms 110, and omits a secondary or ancillary zone for interface mechanisms 120. The layout of, and the functionalities presented via, dashboard 200 may be selectively modified or reprogrammed, for example, via selection of a “Customize Dashboard” option (reference numeral 270), via a “preferences” or “settings” menu item (not shown in FIG. 2), or the like, as is generally known in the art.

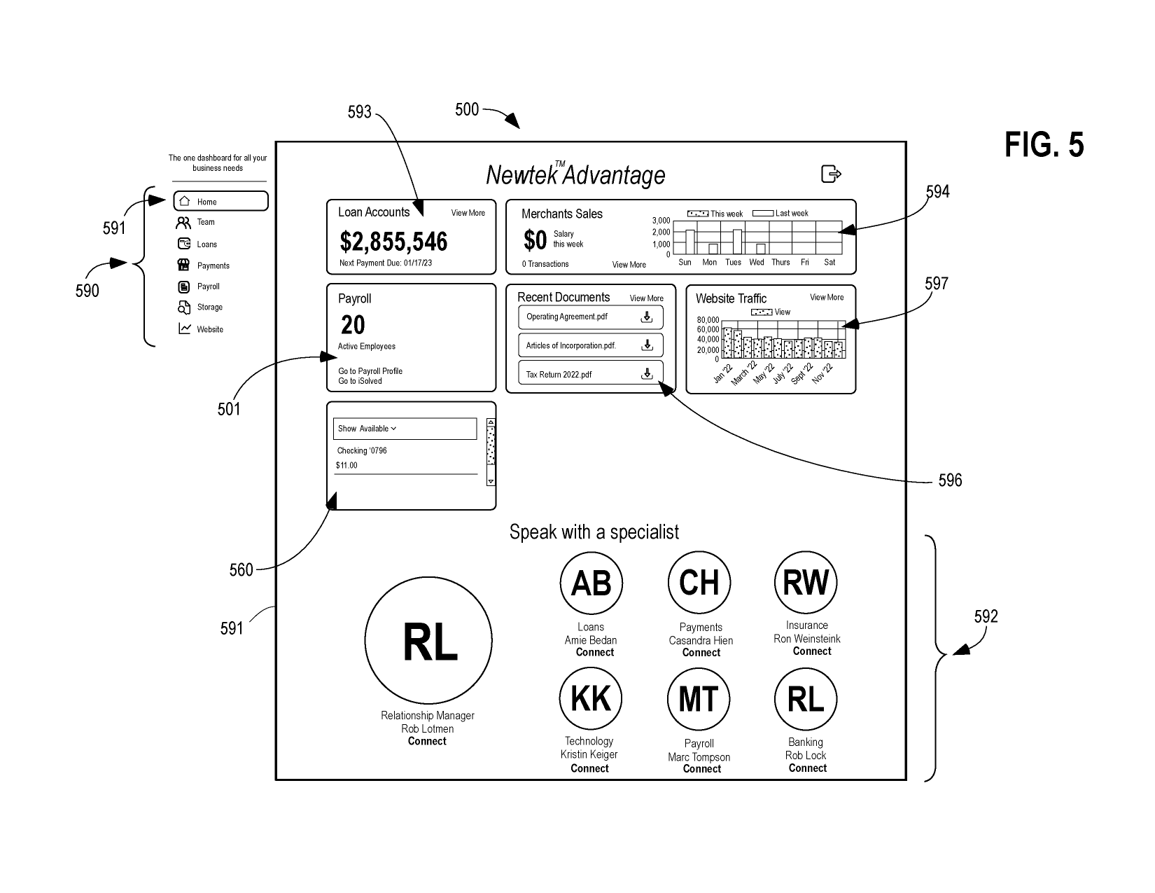

As indicated in FIGS. 1 and 2, functionalities that may be selectively accessible via dashboards 100 and 200 may include, but are not limited to, some or all of the following: loan accounts; bank accounts; credit card accounts or accounts receivable (or payable) information; sales data, marketing data, or both; revenue, projections, or other financial data; payroll or other human resources information such as insurance or medical coverage subsidies or reimbursements; website traffic data or other analytics; or a combination of these and other functionalities that are relevant to an enterprise. Some of these are discussed in greater detail with reference to FIGS. 5 through 16.

As indicated in FIGS. 3 and 4, the data employed to create and to display values in dashboard 100, 200, or 500 (described below), or in any of the various dashboards identified herein, may be internal or “enterprise” data (e.g., in the sense that the data are mined, generated, processed, stored, or otherwise accessed via resources that are owned, managed, or maintained by the enterprise itself). Additionally or alternatively, such data may be external data (e.g., in the sense that the data are, as applicable, mined, generated, processed, stored, and subsequently transmitted to, or otherwise accessed by, the enterprise via networked processing resources that are owned by third parties or that are otherwise independent of the enterprise's computer systems).

In that regard, FIG. 3 illustrates two internal data sources (reference numerals 311 and 312), each of which is providing internal data to a processing resource (reference numeral 399, e.g., a central processing unit or CPU), and two third party data sources (reference numerals 321 and 322), each of which is providing external data to the processing resource 399. This arrangement is illustrated in greater detail in FIG. 4.

Processing resource 399, in turn, may process those received data and provide same to dashboard 100, 200, or 500 (or 1700). In some implementations, raw or processed data may be supplied to a user device (such as device 299, for instance), which may insert such data and/or format such data (i.e., at the remote user device) as applicable and in accordance with the selectable configuration of dashboard 100, 200, or 500 that is instantiated at that particular remote user device. Alternatively, a dashboard such as illustrated and described herein may be constructed or formatted, in whole or in part, at processing resource 399 prior to being transmitted to a remote user device.

FIG. 4 represents a system 499 that is arranged in accordance with one aspect of the present disclosure and generally comprises a processing resource 399, a “local” data store 410, and various modules (labeled “module” and described below) that allow processing resource 399 access to data that are necessary or desirable to create, or to provide processed data that are necessary to create, or render a dashboard such as set forth herein. In operation, a user (reference numeral 490) may access a “single sign on” module (reference numeral 498) to access system 499 resources, including a dashboard (such as 100, 200, 500, and 1700) as set forth in more detail below. In this context, a “single sign on” login procedure may generally allow a user to access multiple features of a multi-functional dashboard—even those that ordinarily would require independent login and authentication—using only a single set of login and authentication credentials that are recognized, honored, and enforced by components of system 499, even in the event that external, third party resources are required for processing, creating, and rendering a dashboard.

In this context, data store 410 may be referred to as “local” in the sense that it may be co-located with processing resource 399, one or more of the modules in FIG. 4, or both. On the other hand, this is not necessary, and data store 410 may be located remotely, as is generally known in the art of distributed computing. Data store 410 may be embodied in or comprise a mass data storage component, such as a non-volatile data storage device, one example of which is an Electronically Erasable Programmable Read Only Memory (EEPROM) store. For example, data store 410 may be, or include, Flash™ memory, though other memory types (such as magnetic or optical discs having spinning media, for instance) having suitable or appropriate characteristics to facilitate the functionality set forth herein may be in use currently or developed in the future. In operation, data store 410 may maintain encoded data and instructions that enable processing resource 399, when accessing those data and executing those instructions, to create or cause creation of the dashboards described herein. Such maintenance of data and instructions is generally known in the art of data storage, and so is not described further here.

The FIG. 4 system 499 also includes, by way of example, several application programming interface (API) connections as follows: a document API 426 may provide documents, document related data or meta data (e.g., file type, file size, date of last edit, etc.), or a combination of these, to a document storage module 496; a core system API 430 may provide banking data and meta data (e.g., account type, account balance, date of last deposit, currency preference, etc.) to a banking module 460; a different core system API 423 may provide loan data and meta data (e.g., loan type, principal balance, interest rate, date of last payment, etc.) to a loan module 493; a website data API 427 may provide website performance, analytics, and access metrics (e.g., number of unique visitors, click engagement and click-through rates, length of typical visit, date of last update, etc.) to a website analytics module 497; a payroll vendor API 425 may provide payroll data and meta data (e.g., employee name, age, tenure, salary, etc.) to a payroll processing module 495; and a payment processor API 424 may provide merchant payment data and metadata (e.g., payment date, point of sale information, payment amount, automated clearing house (ACH) transactional information, etc.) to a merchant processing module 494. It will be appreciated that the depiction of system 499 in FIG. 4 is representative only, and that additional (or fewer) APIs and modules may be deployed as desired, and that the types of data and metadata noted above may be supplemented, augmented, replaced, modified, or omitted, depending upon the type of functionality to be supplied by a dashboard 100, 200, or 500, the processing capabilities of processing resource 399, third party requirements with respect to a single sign on procedure (see reference numeral 498), or a combination of these and a variety of other factors.

API technologies are generally known in the art, and allow the various modules depicted in FIG. 4 to engage in bi-directional data communications with networked components and other resources that are external to system 499; as noted above, “external to system 499” in this context does not necessarily mean that such external resources are not owned, operated, managed, maintained, leased, or otherwise controlled by the same entity that owns and operates system 499. Specifically, the APIs illustrated in FIG. 4 may accommodate ingestion (by components of system 499) of internal data or external data, depending upon the nature of system 499, the functionality provided by the specific module using the data received via the specific API, and the like. For example, website data API 427 may provide internal data that are monitored using in-house website metrology tools, whereas core system API 430 may allow access to external data that are streamed or otherwise transmitted from a third party financial institution. It is also noted that a particular API may be owned by, or influenced by requirements promulgated by, a third party such that access to a data stream supplied by such third party (i.e., external data) must use, or at least be compatible with, certain communications protocols, handshaking technologies, variable naming conventions, or other requirements. Accordingly, the present disclosure is not intended to be limited by any particular API functionality, convention, protocol, or implementation, which may be implemented as necessary or desirable to effectuate the functional interoperability of the various components described herein.

In that regard, though some of the following description is provided in terms of software, instruction sets, or “modules,” it will be appreciated that the underlying functionality may be provided entirely in, or supported by, suitable hardware or firmware implementations. For example, with respect to hardware solutions, those of skill in the art will appreciate that, in addition to, or as an alternative for, microprocessors and microcontrollers typically associated with CPUs, processing resource 399 may be embodied in or comprise application specific integrated circuits (ASICs), field programmable gate arrays (FPGAs), programmable logic controllers (PLCs), programmable single electron transistor (SET) logic components, or combinations of other electronic devices or hardware or firmware components. These may be implemented and suitably configured (via software, firmware, or a combination) to provide some or all of the functionality of processing resource 399 or the various illustrated modules, either individually or in combination. Any selectively configurable or suitably programmable hardware element or combination of elements generally known in the art or developed and operative in accordance with known principles may be employed for both processing resource 399 and the various “modules” shown in FIG. 4.

Specifically, a “module” in the context of the disclosed subject matter, is intended to refer to underlying functionality that enables display of certain data, metadata, and other informative materials via a multi-functional dashboard as set forth herein. Typically, a “module” may refer to a software routine, application, applet, or other self-contained instruction set—if that term were read by a software engineer; conversely, a “module” may refer to a hardware component, card, register set, or other physical electronic component—if that term were read by a hardware engineer. In this application, however, the term “module” is intended to mean either physical hardware components, physical or logical software, code, or other instructions, firmware that is necessary or desirable to enable the hardware components to operate for a intended purpose, or a combination of two or all of the above.

Further, system 499 may generally comprise or be embodied in multiprocessor systems, microprocessor-based or programmable consumer electronics, personal computers (“PCs”), networked PCs, minicomputers, mainframe computers, and similar or comparable apparatus for general purpose or application-specific data processing. Various implementations of system 499 (or even processing resource 399, specifically) may be deployed in distributed computing environments in accordance with which tasks or the functionality provided by the several modules may be performed or executed by remote processing devices, which may be linked through a communications network (not shown); this includes data store 410, which need not be “local,” for instance, and may be implemented as a remote data repository such as a library or database this is networked to system 499 from a location that is different from the one (or ones) in which processing resource 399 resides. Those of skill in the art will appreciate that any of various computer servers, work stations, or other processing hardware components or systems of components may be suitable for implementation at system 499 (and processing resource 399), and that the disclosed subject matter is not limited to any particular hardware implementation or architecture of system 499.

In operation, processing resource 399 may generally aggregate data received from or accessible via the various modules and, in cooperation with data maintained in data store 410 and input from a user 490 via single sign on module 498, may process data to create, or to allow a remote device to create or to render, a dashboard such as described herein (e.g., reference numerals 100, 200, 500, and 1700).

Regarding the various modules, it is noted that document storage module 496 may process, either individually or in cooperation with processing resource 399, documents, document related data or meta data, or a combination of these, for storage (e.g., in data store 399) or for display on a multi-function dashboard. As noted above, the data processed by document storage module 496 may include, without limitation, file type, file size, date of last edit, and the like, as may be relevant or desirable to be stored in connection with a document that is to be accessed via a multi-function dashboard. One purpose of this module is to create a repository (e.g., in data store 410 and accessible via document storage module 496) of important or readily accessible documents that are easily referenced or retrieved during use of system 499 and any attendant dashboard 100, 200, 500, or 1700.

Similarly, banking module 460 may process, again either individually or in cooperation with processing resource 399, banking data and meta data for storage, display, or both. As noted above, the data processed by banking module 460 may be related to, without limitation, account type, account balance, date of last deposit, currency preference, responsible bank officer or contact, and the like, again, as may be relevant or desirable to be stored in connection with a bank account that is to be accessed via a multi-function dashboard. Many of these data may be external data, acquired from an independent third party financial institution, for example, though some may be internal, e.g., mined from data store 410 and only related to the external data, though internally maintained. One purpose of this module may be to create a repository (e.g., in data store 410 and accessible via banking module 460) of important or readily accessible bank account information that is easily referenced or retrieved during use of system 499 and any attendant dashboard 100, 200, 500, or 1700.

In one implementation, a loan module 493 may process, either individually or in cooperation with processing resource 399, loan data and meta data for storage, display, or both. As noted above, the data processed by loan module 493 may be related to, by way of example, loan type, principal balance, interest rate, date of last payment, and the like, and may vary on a case by case basis, as applicable. As in the case of banking module 460, many of these data processed by loan module 493 may be external data, acquired from an independent third party financial institution, though some may be internal and maintained in data store 410. One purpose of this module may be to create a repository (e.g., in data store 410 and accessible via loan module 493) of important or readily accessible loan, mortgage, or lien information that is easily referenced or retrieved during use of system 499 and any attendant dashboard 100, 200, 500, or 1700.

A website analytics module 497 may process, either individually or in cooperation with processing resource 399, website performance, analytics, and access metrics for storage, display, or both. As noted above, the data processed by website analytics module 497 may include, among other relevant statistics, a number of unique visitors that visit a website per unit of time, click engagement and click-through rates, length of a typical visit by first-time visitors, date of last update, specific pages that tend to make visitors leave the site, and the like. Many of these data may be internal data, acquired from in-house enterprise tools, though some may be received by, or derived from, external data from an independent third party such as an internet service provider or web hosting enterprise. One purpose of this module may be to create a repository (e.g., in data store 410 and accessible via website analytics module 497) of important or readily accessible website usage information that is easily referenced or retrieved during use of system 499 and any attendant dashboard 100, 200, 500, or 1700.

A payroll processing module 495 may process, either individually or in cooperation with processing resource 399, payroll data and meta data for storage, display, or both. As noted above, the data processed by payroll processing module 495 may include, among other relevant information employee names, ages, tenures, salaries, profit sharing contributions, insurance beneficiaries, and so forth. Many of these data may be internal data, acquired from in-house enterprise tools, though some may be received by, or derived from, external data from an independent third party such as an employee's retirement saving plan account balances, investment portfolio risk tolerances, and other personal information provided to third party financial planners or financial institutions. One purpose of this module may be to create a repository (e.g., in data store 410 and accessible via payroll processing module 495) of important or readily accessible payroll and employee preference information that is easily referenced or retrieved during use of system 499 and any attendant dashboard 100, 200, 500, or 1700.

A merchant processing module 494 may process, either individually or in cooperation with processing resource 399, merchant payment data and metadata for storage, display, or both. As noted above, the data processed by merchant processing module 494 may generally include, without limitation, payment date, point of sale information, payment amount, ACH transactional information, vendor fees, dispute resolution procedures, vendor contact information, and the like. One purpose of this module may be to create a repository (e.g., in data store 410 and accessible via merchant processing module 494) of important or readily accessible transaction information that is easily referenced or retrieved during use of system 499 and any attendant dashboard 100, 200, 500, or 1700.

Those of skill in the art of data processing will appreciate that the structural arrangement of system 499 depicted in FIG. 4 is representative only, and that additional (or fewer) APIs and modules may be deployed as desired, and that the types of data and metadata noted above may be supplemented, augmented, replaced, modified, or omitted, depending upon the type of functionality to be supplied by a dashboard 100, 200, 500, or 1700, the processing capabilities of processing resource 399, third party requirements with respect to a single sign on procedure (see reference numeral 498) or other data security considerations, or a combination of these and a variety of other factors.

Specifically, it is noted that system 499 may be implemented with any number of additional components, modules, or functional blocks such as are generally known in the electronic and data processing arts; the number and variety of components incorporated into or utilized in conjunction with system 499 may vary in accordance with, among other factors, overall requirements of system 499, hardware capabilities or interoperability characteristics of the components thereof, desired performance metrics, or other application-specific factors.

FIG. 5 is a view of one embodiment of a multi-functional dashboard user interface, such as that shown in FIG. 1, having connected accounts and customizable information displays. As with dashboards 100 and 200, the dashboard 500 illustrated in FIG. 5 may generally comprise a number of discrete user interface mechanisms allowing access to diverse and varied functionality. In FIG. 5, these interface mechanisms are generally represented by reference numerals 560 and 591 through 597, but may also include a menu or selection area (depicted at reference numeral 590) having representative icons or thumbnails which may also allow selection of or navigation to particular functionality via a mouse “click,” touch screen “tap,” or other familiar graphical user interface selection mechanism.

As noted above with reference to FIGS. 1 and 2, dashboard 500 may be selectively customizable, programmable, or otherwise dynamically adjustable, such that a particular size, orientation, and location of any or all of interface mechanisms 560 and 591-597 (and others) may be altered to suit a particular user's needs or tastes. For example, interface mechanism 592 may be moved to the top of dashboard 500 as displayed on a screen, or re-oriented to vertical rather than horizontal, while other interface mechanisms may then be situated to accommodate such a new placement or orientation. Full customization options and user preferences related to the content and location of interface mechanisms 560 and 591-597 to be displayed on (and accessible via) dashboard 500 may be selected via a “preferences” or “settings” menu (not shown in FIG. 5) or via a button, icon, or other selectable option such as the “Customize Dashboard” option (reference numeral 270) described above with reference to FIG. 2. In operation, a particular user of customizable dashboard 500 may be enabled to cluster, size, locate, or orient related, similar, or equally important interface mechanisms 560 and 591-597 in a layout that makes interaction with dashboard 500 functionalities efficient for that particular user.

Back-end code and other technologies useful for rearranging the presentation of widgets, applets, and other functional blocks on a display (such as a browser page) are generally known in the art, and so are not described in greater detail here, though it will be appreciated that the disclosed subject matter is not intended to be limited to any particular code or protocol to alter the size, location, or orientation of an interface mechanism 560 and 591-597 in connection within the overall landscape of dashboard 500.

Dashboard 500 may include a “home” (or “default”) display 501 and include, in some instances, a “return to home” function depicted as a selectable icon (reference numeral 591) in menu 590, as is typical with many website and other software navigation paradigms. This home display 501 is what is presented to a user upon initial access to system 499 via single sign on module 498, and at any other time that a user navigates to home display 501 by choice. For example, during navigation of the functionalities provided by system 499, selecting the “Home” icon 591 from menu 590 may return a user to the home display 501 of dashboard 500 that is depicted in FIG. 5. This “return to home” functionality is also indicated as an option in menu 190 illustrated in FIG. 1.

As indicated in FIG. 5, additional functionalities that may be selectively accessible via dashboard 500 may include, but are not limited to, some or all of the following: bank accounts (reference numeral 560—see banking module 460); important internal or external personnel and their respective titles, expertise, and contact information (reference numeral 592); loan accounts (reference numeral 593—see loan module 493); credit card accounts or accounts receivable (or payable) information (reference numeral 594—see merchant processing module 494); payroll or other human resources information such as insurance or medical coverage subsidies or reimbursements (reference numeral 595—see payroll processing module 495); documents and related metadata (reference numeral 596—see document storage module 496); and website traffic data or other analytics (reference numeral 597—see website analytics module 497); or a combination of these and other functionalities that are relevant to an enterprise. As noted above with reference to FIGS. 1 and 2, among other things, dashboard 500 may be configured and operative to display some or all of the following: sales data, marketing data, or both; revenue, projections, or other financial data; rosters, rolls, or team member data; or any other data necessary or desirable for an enterprise to track, which may be organization- or application-specific.

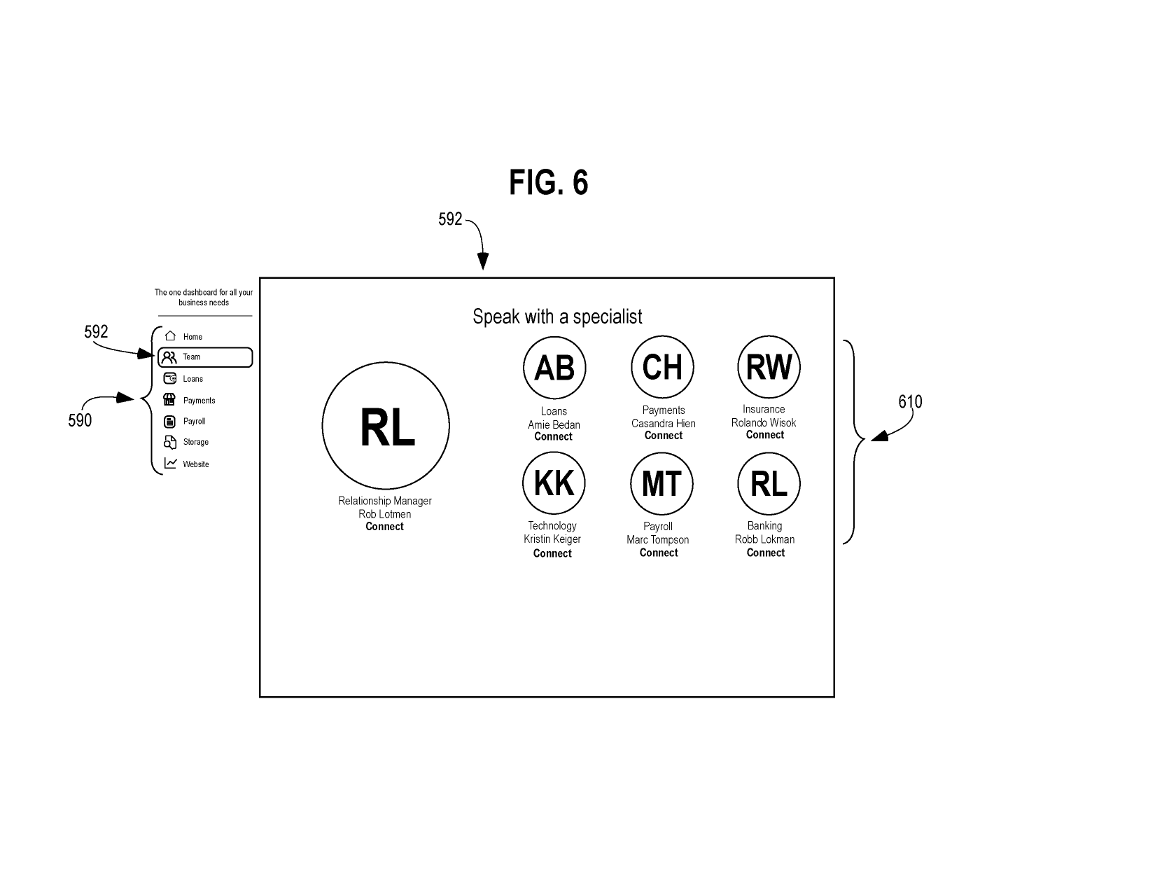

Looking at each of the foregoing functionalities in more detail, FIGS. 6 through 16 illustrate aspects of certain functional components of the multi-functional dashboard user interface of FIG. 5.

A “team” (or “personnel” or “contacts”) display (reference numeral 592) may be accessed from home display 501 or via selection of an icon 592 in menu 590, as illustrated in FIG. 6. Contact information, or hyperlinks to such contact information, may be accessible as indicated at reference numeral 610. As noted above, internal or external personnel may be listed here, along with user selectable or predetermined data, including but not limited to the following, as applicable or desirable: corporate title or role; technical, legal, financial, administrative, or other expertise; contact information such as telephone number or electronic mail address; tenure of relationship (“10 years as trusted advisor”); office hours or other availability data; and the like.

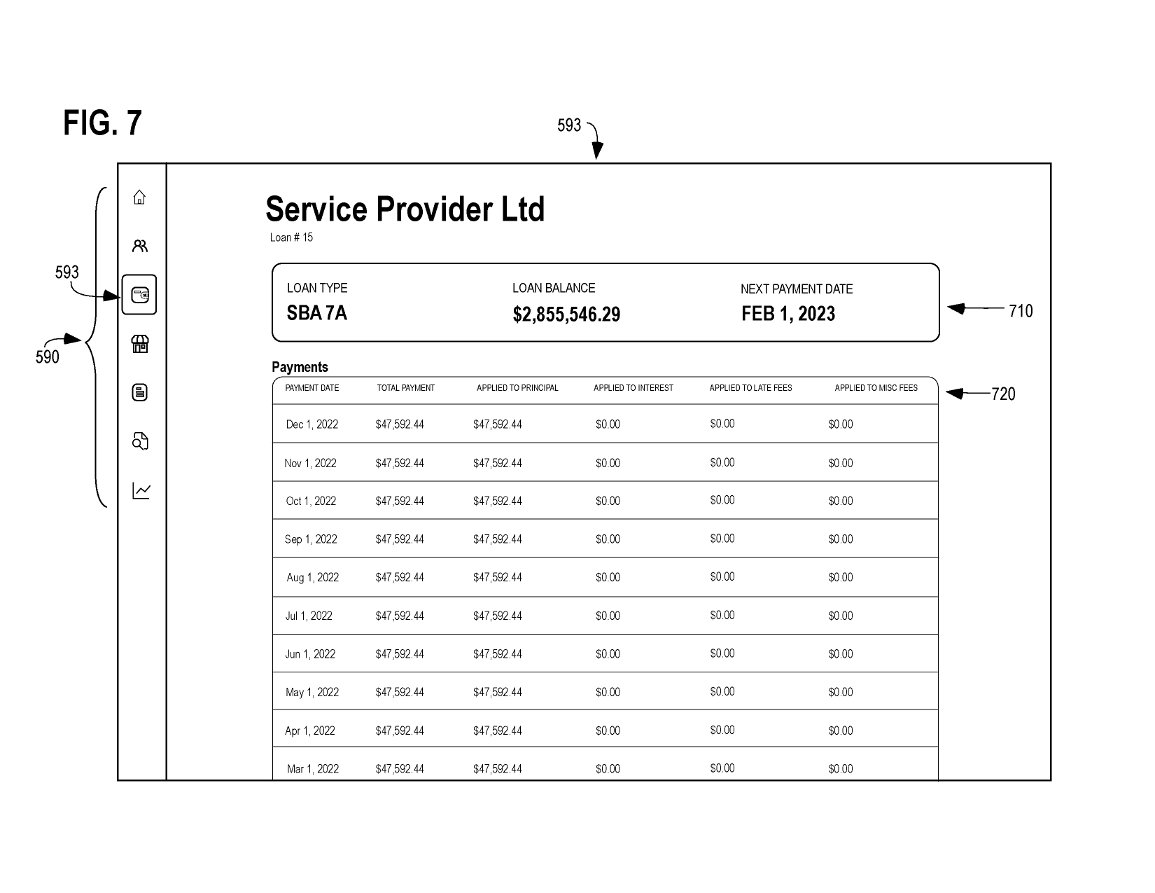

A “loan accounts” display (reference numeral 593) may be accessed from home display 501 or via selection of an icon 593 in menu 590, as illustrated in FIG. 7. Various data related to loans, mortgages, liens, or other debts owed may be processed, for example, by loan module 493 (optionally in cooperation with or under control of processing resource 399) and displayed at loan accounts display 593, as applicable or desired. By way of example, FIG. 7 shows primary loan information (reference numeral 710) such as loan type, balance, and payment due date; additional information, such as historical data, may be also be displayed as illustrated at reference numeral 720. Additionally, one or more toggle switches, arrow selectors, or other menu options (not shown for the sake of clarity) may allow a user selectively to switch between or amongst different loan accounts such that review of relevant data for any of a variety of different loans is possible via loan accounts display 593.

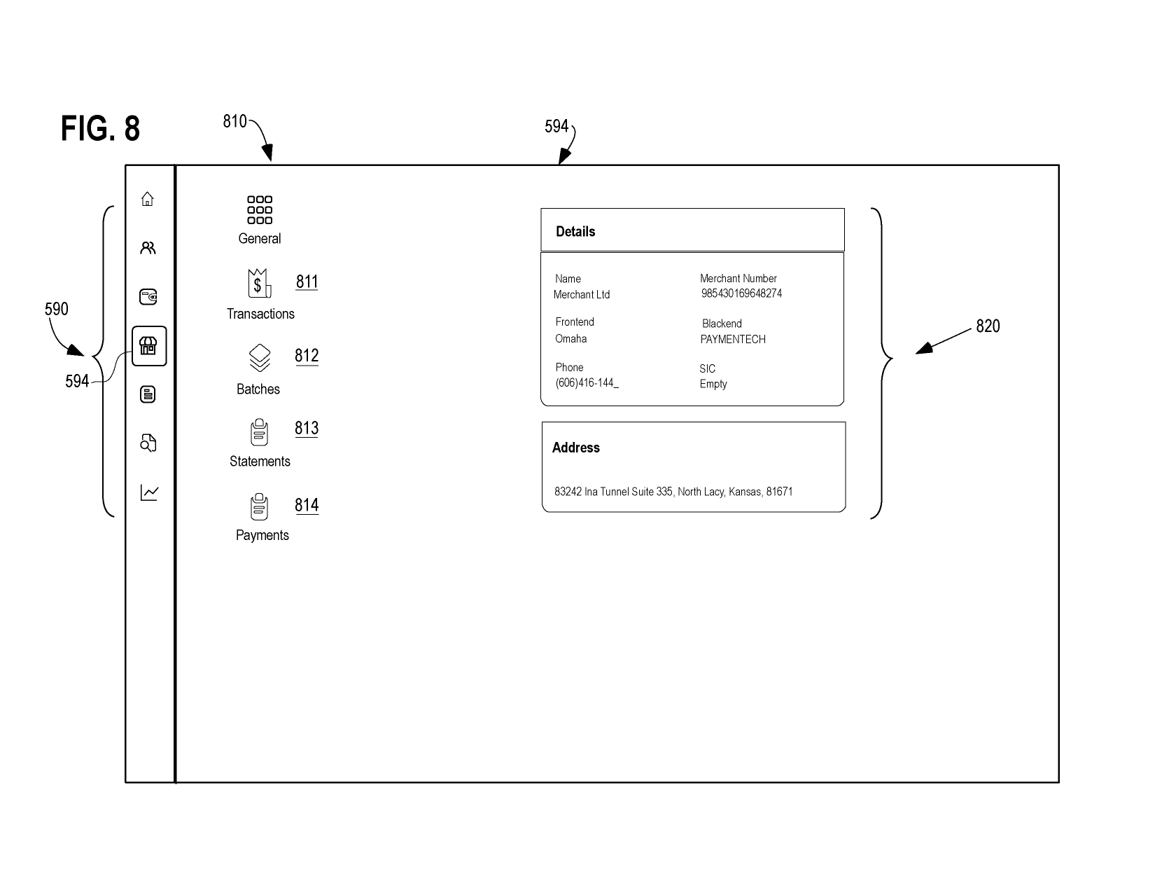

A “credit card accounts” display (reference numeral 594) may be accessed from home display 501 or via selection of an icon 594 in menu 590, as illustrated in FIG. 8. Credit card account or accounts receivable (or payable) information may be selectively displayed on credit card accounts display 594. As set forth above with reference to merchant processing module 494, data provided by credit card accounts display 594 may generally include, without limitation, payment date, point of sale information, payment amount, ACH transactional information, vendor fees, dispute resolution procedures, vendor contact information, and the like. Some of these data are illustrated in FIG. 8 at reference numeral 820, and include vendor or merchant name and contact information, relevant codes or identifiers, and other high-level information (such as may be internal and proprietary, for example, or vendor-supplied) that may be useful or necessary to identify a vendor.

As with the loan accounts display 593 described above, one or more toggle switches, arrow selectors, or other menu options (again, not shown for the sake of clarity) may allow a user selectively to switch between or amongst different credit card accounts such that selective review of relevant data for any of a variety of different accounts is possible via credit card accounts display 594. Navigation tools to enable this feature are well known in the art, and so are neither illustrated nor described in detail.

In operation, credit card accounts display 594 may access, and make available for presentation, data maintained in a repository (e.g., in data store 410) related to credit transactions, and may further provide (as a further navigational aid) a submenu 810 to enable efficient access to desired data or portions of a relevant database. Specifically, submenu 810 may include, among other functionalities or navigation options that are not shown in FIG. 8, options allowing a user to focus on transactions (icon and reference numeral 811), transaction batches (icon and reference numeral 812), account statements (icon and reference numeral 813), and payments (icon and reference numeral 814), each of which may link to or otherwise provide access to additional functionality of dashboard 500, in general, and credit card accounts display 594, in particular.

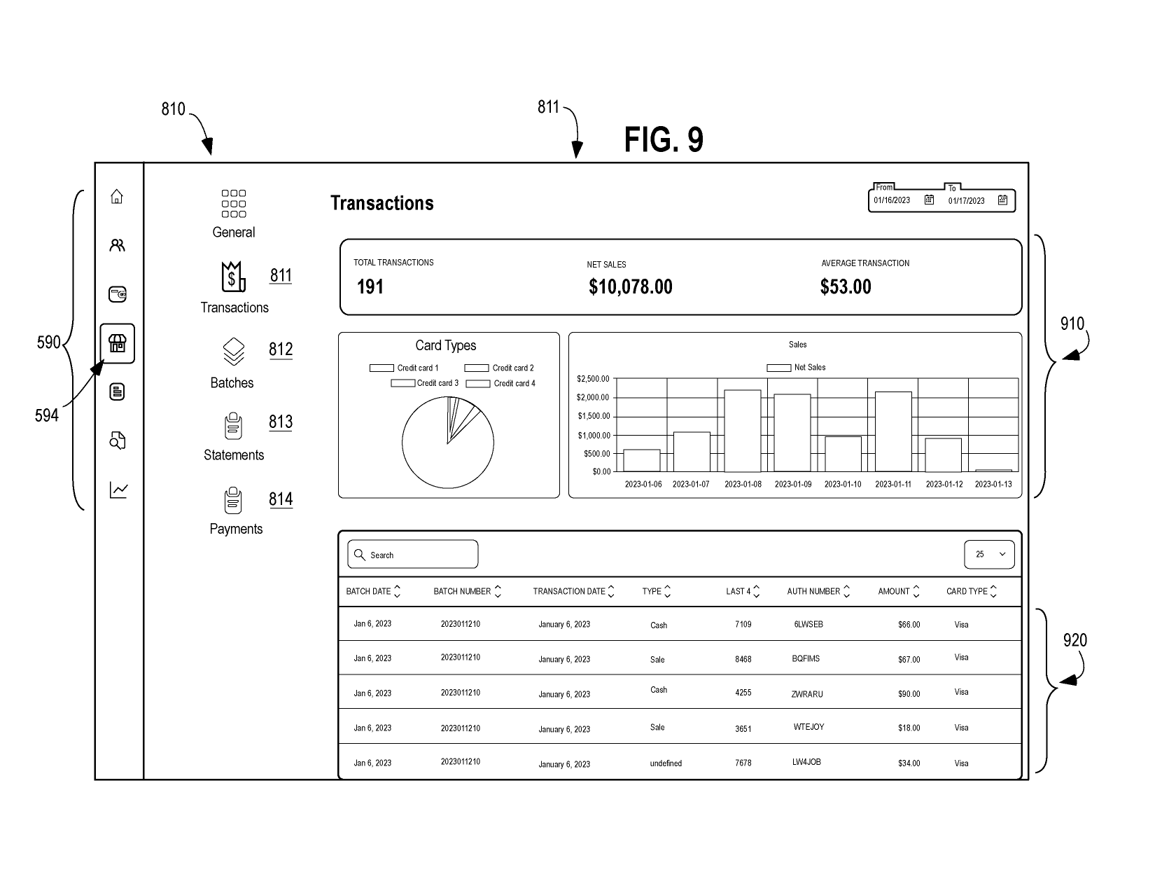

Transaction display 811 (FIG. 9) may generally present overview, aggregated, or high-level transaction data at reference numeral 910, and may also allow a more detailed investigation of specific transactions through selection of a particular line item as indicated at reference numeral 920. Specific date ranges (such as fiscal quarter or tax year) may be selected, sales versus purchases may be toggled, and the various data points to be displayed may be selected via typical “settings” or “preferences” menu options (not shown). As described above with reference to FIG. 1, the locations, sizes, and orientations of the fields in which data 910 and line items 920 are depicted may be selectively altered or adjusted.

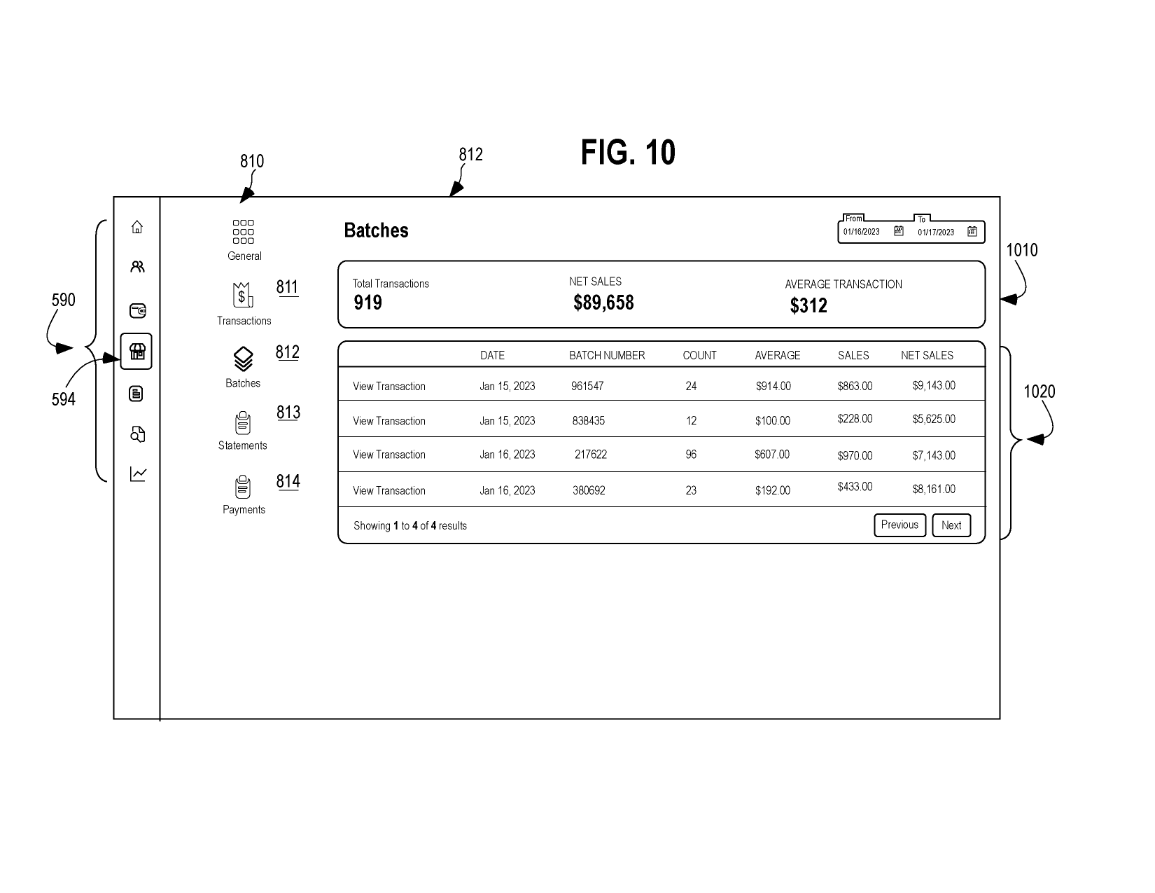

Transaction batch display 812 (FIG. 10) may generally present overview, aggregated, or high-level transaction batch data at reference numeral 1010, and may also allow a more detailed investigation of specific transaction batches through selection of a particular line item as indicated at reference numeral 1020. As with transaction display 811, specific date ranges (such as fiscal quarter or tax year) may be selected, sales versus purchases may be toggled, and the various data points to be displayed may be selected via typical “settings” or “preferences” menu options (not shown); the locations, sizes, and orientations of the fields in which data 1010 and line items 1020 are depicted may also be selectively altered or adjusted.

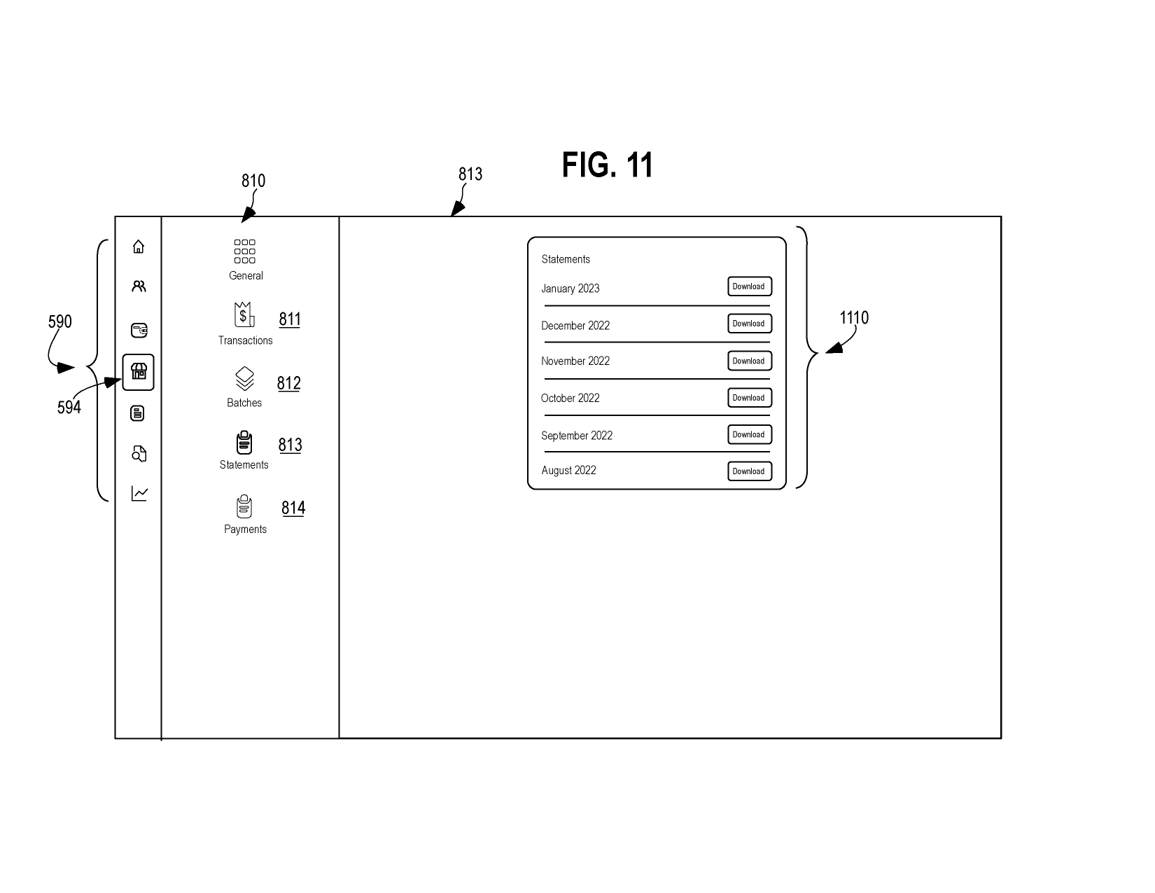

Account statements display 813 (FIG. 11) may generally present a list of account statements that may be accessed (e.g., via hyperlink or other linked list) at reference numeral 1110. In this particular implementation, a more detailed investigation of specific account balances may be enabled via selection of a particular line item at reference numeral 1110 (see the “Download” selection option at each line), though other options are possible. For example, check boxes, radio buttons, or other selection mechanisms may be used to allow selection of multiple statements (either for the same account or for different accounts) to be accessed, downloaded, printed, etc. simultaneously or in series. Again, it may be desirable to provide a user with options to select specific date ranges (such as fiscal quarter or tax year), accounts, account types, and whether an account is an account payable or receivable, among other things, at account statements display 813. User interface widgets, accessories, or other instruments to effectuate these options have been omitted for clarity, but are familiar to those of skill in the art; it is also true that these features may be menu-driven.

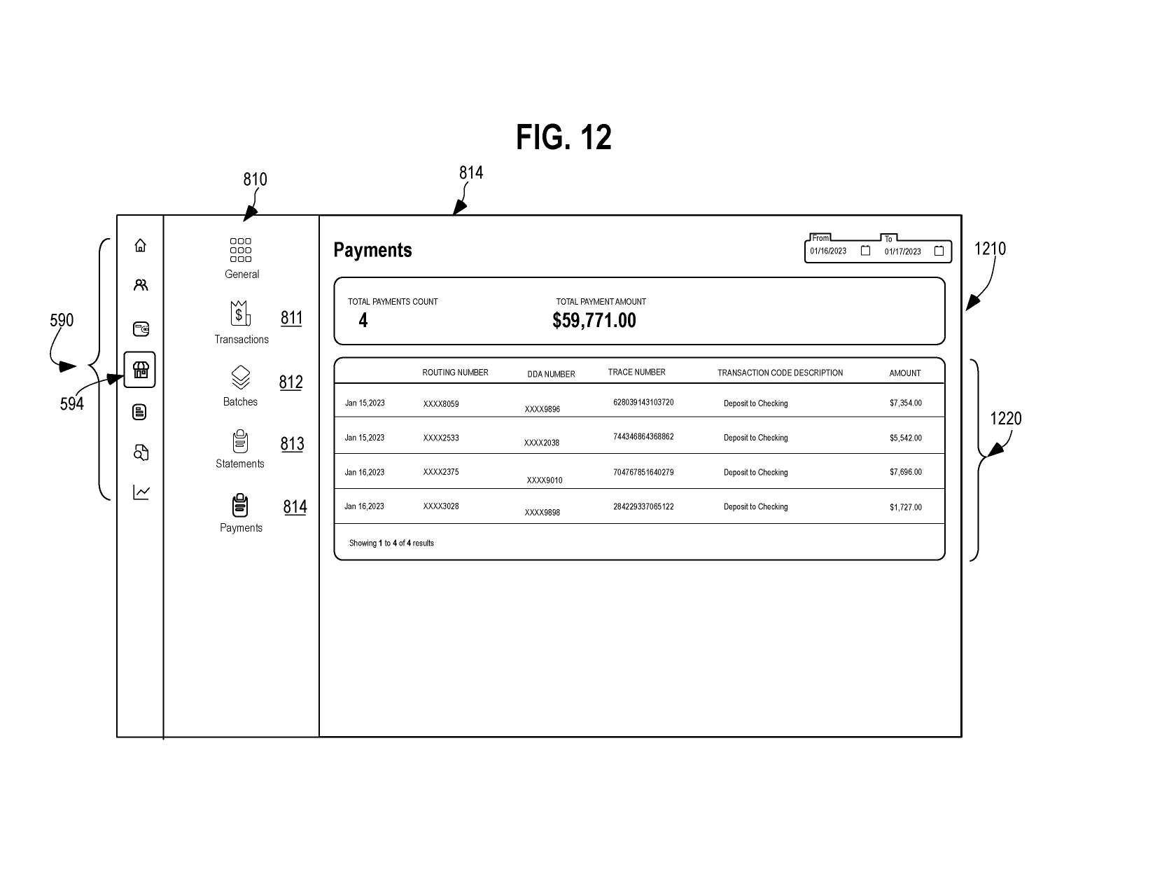

Payments display 814 (FIG. 12) may generally present overview, aggregated, or high-level payment (either accounts payable or accounts receivable) data at reference numeral 1210, and may also enable a more detailed investigation of specific transactions through selection of a particular line item as indicated at reference numeral 1220. Specific date ranges (such as fiscal quarter or tax year) may be selected, sales versus purchases may be toggled, and the various data points to be displayed may be selected via typical “settings” or “preferences” menu options (not shown). As described above with reference to FIG. 1, the locations, sizes, and orientations of the fields in which data 910 and line items 920 are depicted may be selectively altered or adjusted. Typical navigational aids may be provided, such as indicated in the “Previous” and “Next” buttons in the lower right of payments display 814.

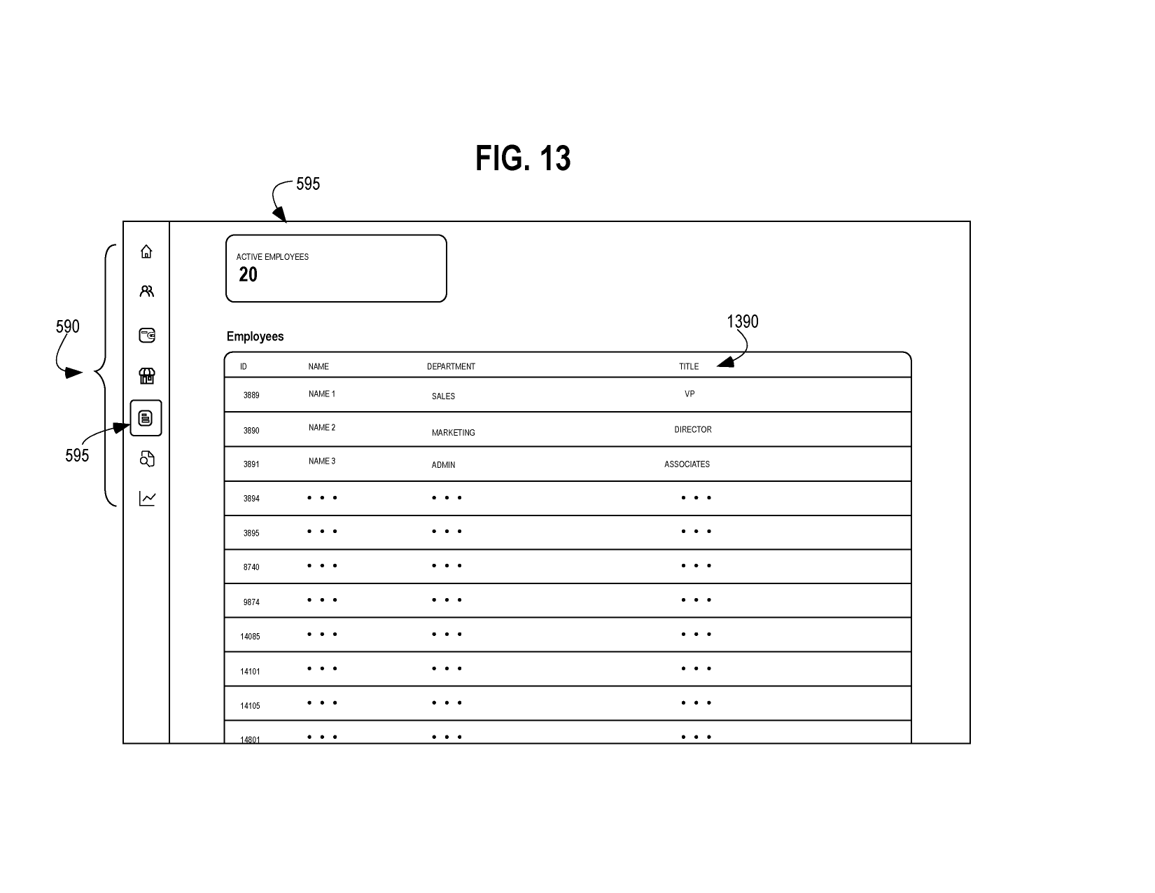

A “payroll” display (reference numeral 595) may be accessed from home display 501 or via selection of an icon 595 in menu 590, as illustrated in FIG. 13. Payroll or other human resources information such as insurance or medical coverage subsidies or reimbursements may be selectively displayed on payroll display 595. As set forth above with reference to payroll processing module 495, data provided by payroll display 595 may generally include, without limitation, employee identification number or serial number, employee name, relevant department, and corporate title, all of which are illustrated at reference numeral 1390; additional information that may be available includes, for one or more employees, as available and as applicable, age, tenure, salary, bonus structure, profit sharing contributions, insurance beneficiaries, and so forth. While, as noted above, some of these data are illustrated at reference numeral 1390, it is noted that much additional information may be relevant or desirable for presentation at payroll display 595.

In particular, payroll processing module 495 may maintain (or provide access to) a repository of data regarding personnel and each individual's personal status, including compensation, bonus eligibility, marital status, insurance beneficiaries, elected medical benefits, historical performance or production, and other records maintained by the human resources department. Access to these and other records may be enabled via selection of a particular line item (e.g., related to a person or an employee number) at reference numeral 1390 via payroll display 595.

It is noted, however, that dissemination or distribution of some of these data points or other personally identifiable information may be governed by or otherwise subject to restrictions associated with corporate data security policies or procedures, industry best practices guidelines, or governmentally imposed data privacy laws or regulations, such as the Health Insurance Portability and Accountability Act (HIPAA), the General Data Protection Regulation (GDPR), the California Consumer Privacy Act (CCPA), or a combination of these. Accordingly, it may be desirable to restrict access to payroll display 595, to the data accessible via the line items or the links illustrated at reference numeral 1390, or both. For example, password or other verified access may be provided to certain authorized individuals (such as those on a human resources or legal team), while access to other individuals without verified credentials is prohibited.

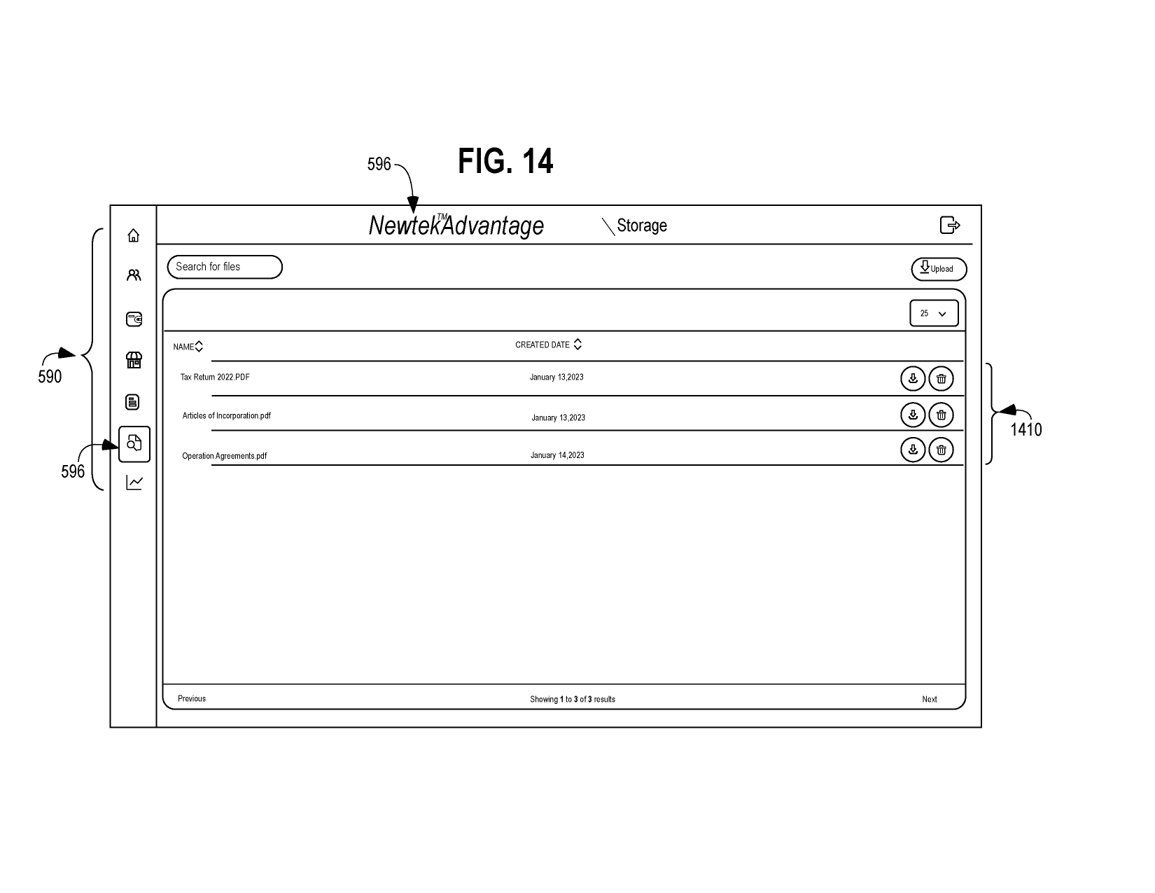

A “documents” display (reference numeral 596) may be accessed from home display 501 or via selection of an icon 596 in menu 590, as illustrated in FIG. 14, and may generally present a list of enterprise documents that may be accessed (e.g., via hyperlink or other linked list) at reference numeral 1410. In that regard, accessible documents (or thumbnails or links to documents) and related metadata may be selectively displayed in a list at 1410 on documents display 596; “download” or “save” and “discard” or “trash” options may also be provided, as indicated at the right of FIG. 14. As set forth above with reference to document storage module 496, data presented by or in connection with documents display 596 may include file name and creation date (both of which are shown at reference numeral 1410), type, file size, date of last edit, and the like, as may be relevant or desirable to be stored and retrieved in connection with a document that is maintained by system 499 (e.g., such as in data store 410).

In the implementation illustrated in FIG. 14, a more detailed investigation of specific documents may be enabled via selection of a particular line item at reference numeral 1410 (see the “Download” selection option at each line), though other options are possible. For example, check boxes, radio buttons, or other selection mechanisms may be used to allow selection of multiple documents to be accessed, downloaded, printed, etc. simultaneously or in series. Again, it may be desirable to provide a user with options to select specific date ranges (such as for “Created Date” or “Date Last Edited”), subject matter (e.g., “Finance,” “Internal Policy,” “Sales Pitch,” etc.), or other metadata associated with a document at documents display 596. In this manner, the list of documents presented at 1410 may be selectively controlled, limited, or filtered as desired by a use of system 499. User interface widgets, accessories, or other instruments to effectuate these options have been omitted for clarity.

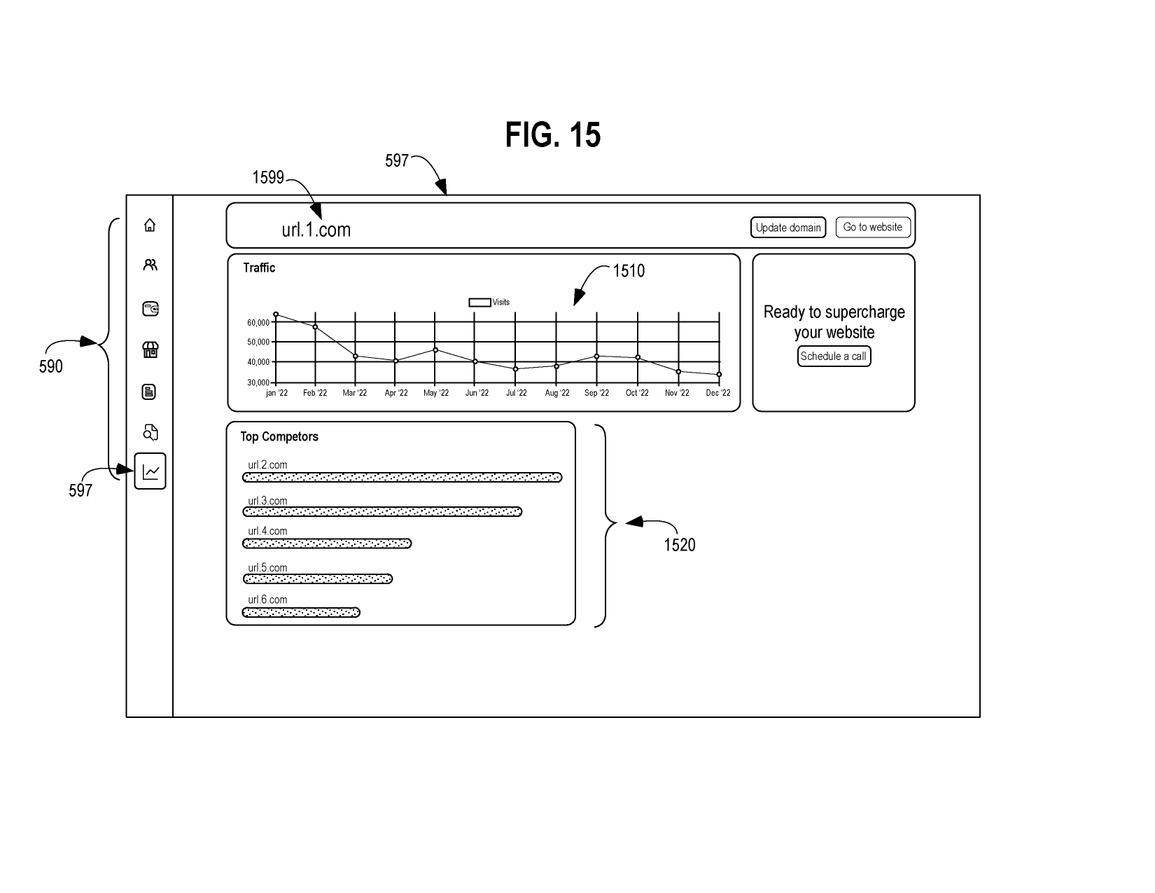

A “website analytics” display (reference numeral 597) may be accessed from home display 501 or via selection of an icon 597 in menu 590, as illustrated in FIG. 15. As noted above with reference to website analytics module 497 in the discussion of FIG. 4, website analytics display 597 may be operative to present various data related to or associated with website performance, analytics, and access metrics. Specifically, the data presented by website analytics display 597 may include, among other relevant statistics, the domain name or uniform resource locator (URL) being analyzed (reference numeral 1599), a number or graphical representation of unique visitors, return visitors, or both, that visit a website per unit of time (or “traffic,” as indicated at reference numeral 1510), click engagement and click-through rates, length of a typical visit by first-time visitors, date of last update, specific pages that tend to make visitors leave the site, performance of competitors' websites for similar URLs (reference numeral 1520), and the like.

It will be appreciated that some data depicted at website analytics display 597 (such as at reference numeral 1510) may be internal to the owner or operator of system 499, and some (such as at reference numeral 1520) may, by necessity, be external (i.e., acquired from third parties such as internet service providers, domain name hosts, third party metrology tool vendors, and the like). The present disclosure is not intended to be limited by the nature of the data presented at website analytics display 597 or by the arrangement, size, or orientation of the fields or windows that depict same in the context of website analytics display 597.

A “banking” display (reference numeral 560) may be accessed from home display 501, for instance, via selection of an icon 560, such as illustrated in FIG. 5. Additionally or alternative, a navigable icon may be included (e.g., as a design choice) in menu 590, or a selectable menu item may be included in home display 501, if desired. As noted above with reference to banking module 460 in the discussion of FIG. 4, banking display 560 may be operative to present various data related to or associated with account type, account balance, date of last deposit, currency preference, responsible bank officer or contact, and the like, again, as may be relevant or desirable to be retrieved or accessed in connection with a bank account.

Specifically, banking display 560 may include, among other relevant statistics for each respective bank account, a familiar or typical navigation menu 1630, a “settings” or “information” application submenu 1650, a messages field, window, or pane 1690, a “primary” or “first” data zone 110, and a “secondary” or “second” data zone 120.

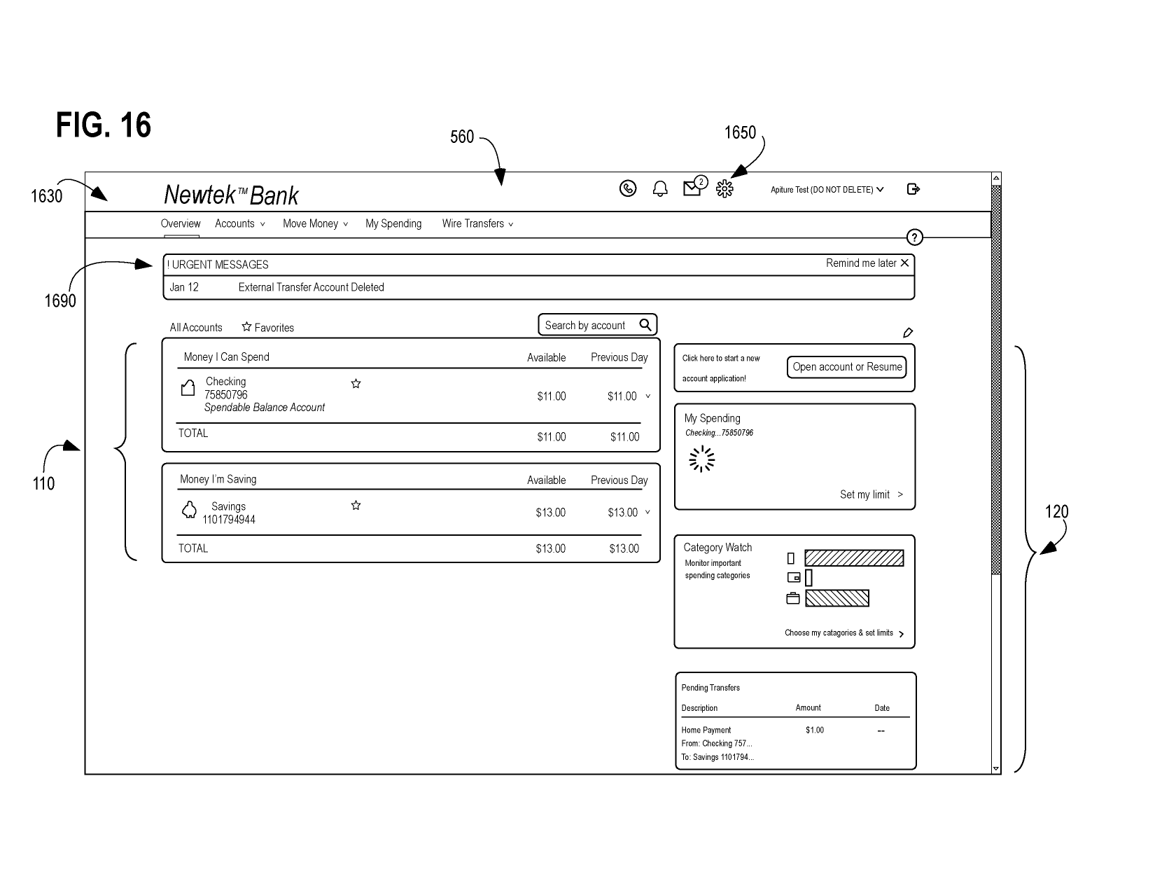

Conventionally, navigation menu 1630 and submenu 1650 are anchored to the top of most user interface displays, though each, individually or collectively, may selectively be moved or reoriented to a side or to the bottom of banking display 560, as desired. As depicted in FIG. 16, navigation menu 1630 includes links to (from left to right) an overview display (that which is shown in FIG. 16), bank account data, asset transfer tools, spending or savings metrics and analytical data, and wire transfer options, though it will be appreciated that many other options may be appropriate as a design choice or as a function of the overall operability goals for or capabilities of system 499. It is also noted that the options available in navigation menu 1630 may differ as a function of availability or operational characteristics of third party systems such as banks and other financial institutions.

Submenu 1650 may generally include links (or icons capable of linking) to resources associated with (from left to right) telecommunications options, alarm, alert, or timing functions, messaging or text communications options, and settings or preferences. As with navigation menu 1630, the options available in submenu 1650 may be application-specific, and may vary as a function of third party service offerings or other considerations. In operation, the foregoing and other features may be accessed, altered, adjusted, or otherwise customized by selection of a familiar user interface option, “clickable” feature, or link—in the case of FIG. 16, this may be the “cog” or “geared wheel” icon in the upper right, at the far right of submenu 1650.

Messages field 1690 may present messages to a user of system 499, as is typical in the art of user interfaces. Messages displayed here may be the same or different from the messaging or text communications identified in or linked from submenu 1650. For example, messages in or linked from submenu 1650 may be from (or to) a third party (i.e., external) services provider or financial institution, while messages in or linked from messages field 1690 may be from (or to) and internal resource, or vice-versa. In some implementations, it may be desirable that the content and extent of messages field 1690 are user-selectable or otherwise dynamically adjustable.

As with the zones described above with reference to FIG. 1, first data zone 110, and second data zone 120 may be relocated, resized, and reoriented as desired. As illustrated in FIG. 16, first zone 110 includes high-level bank account data for at least two accounts, while second zone 120 includes more detailed information regarding expenditures. Those of skill in the art will appreciate that the arrangement of the information displayed, and the information organized into zones 110 and 120 may be altered, omitted, rearranged, or otherwise manipulated as a function of user preference or based upon other considerations.

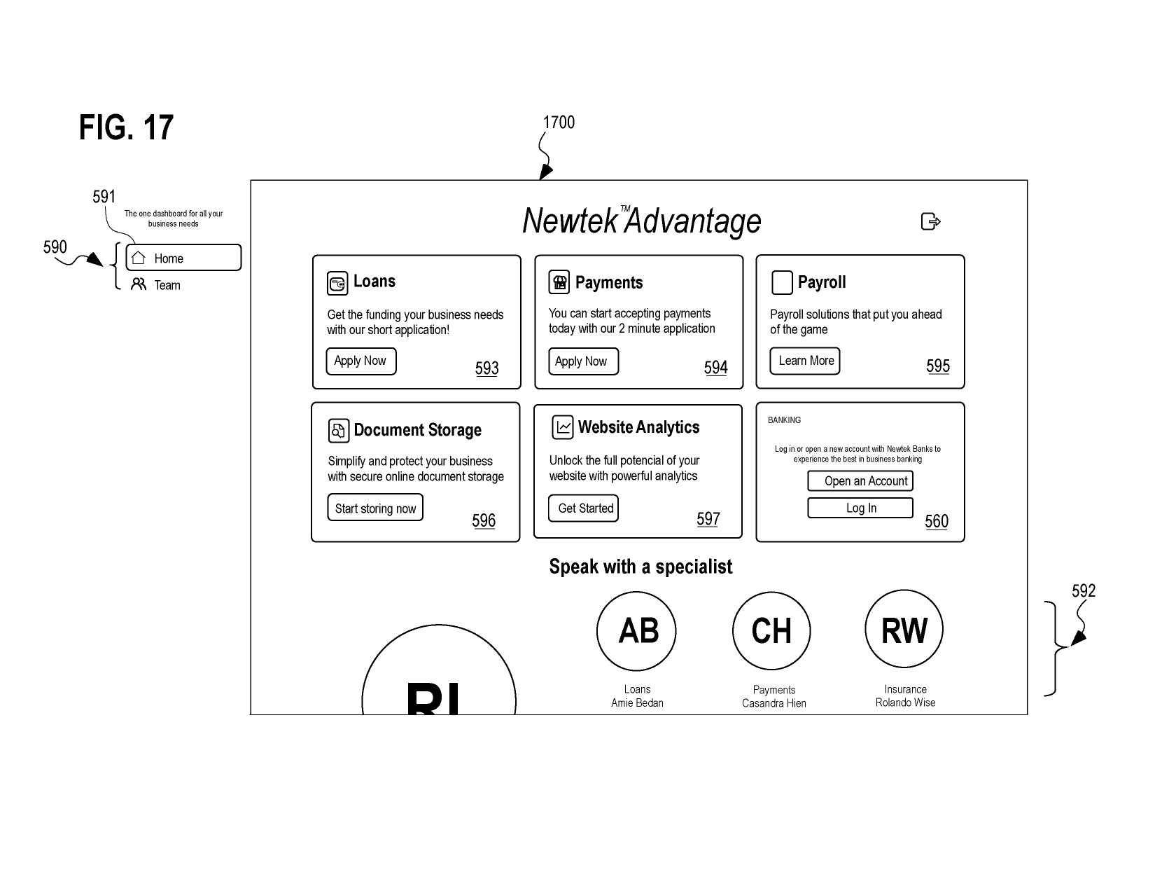

FIG. 17 is a view of one embodiment of a multi-functional dashboard user interface, such as that shown in FIG. 5, having customizable information displays, but no connected accounts. In the case of FIG. 17, the configuration of dashboard 1700 represents a situation in which no accounts (see FIGS. 7-12 and 16) are linked to or recognized by system 499.

A familiar “return to home” function is depicted as a selectable icon (reference numeral 591) in an abbreviated menu 590—simplified to account for the fact that no selectable items have been activated, yet. As noted above with reference to FIGS. 1, 2, and 5, dashboard 1700 may be selectively customizable, programmable, or otherwise dynamically adjustable, such that a particular size, orientation, and location of any or all of interface mechanisms 560 and 591-597 (and others) may be altered to suit a particular user's needs or tastes.

In addition to the “home” function, FIG. 17 also illustrates links or other access to the following, though other options are possible, depending upon application: banking display 560; team display 592; loan accounts display 593; credit card accounts display 594; payroll display 595; documents display 596; and website analytics display 597. Operation of these features may be substantially as set forth above, though some features' availability or operational characteristics may be influenced or dictated by third party (i.e., external) data, policies, and processing requirements.

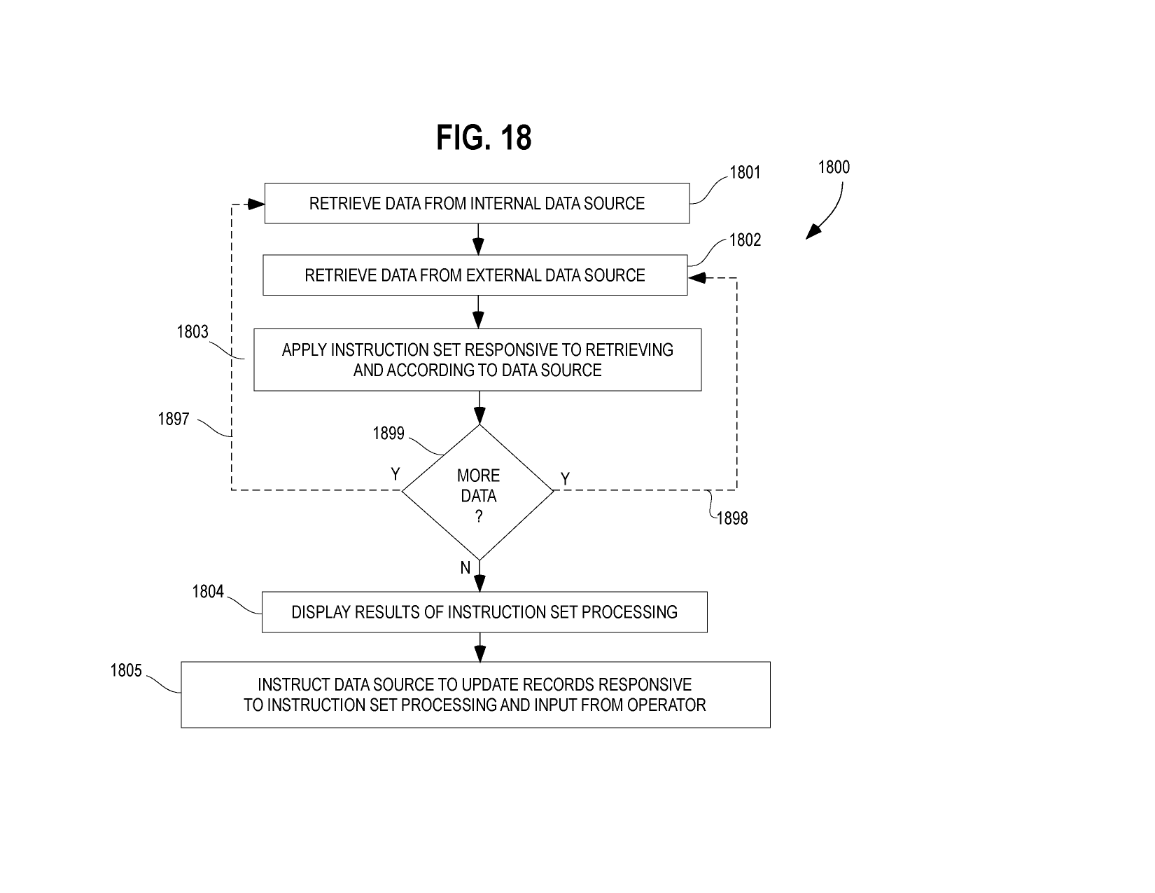

FIG. 18 is a functional flow diagram illustrating aspects of one implementation of a method of displaying and updating records using a multi-functional dashboard user interface.

At block 1801, a method 1800 may begin with retrieving data from an internal data source. As noted above, in this context, the concept of “internal” is intended to be read broadly enough to mean a data source that is owned, operated, managed, maintained, leased, or otherwise controlled by the same entity that owns and operates a processing system (such as system 499, for example) that executes method 1800. Examples of such internal data sources noted above include “in-house” or “enterprise” sales tracking software packages, payroll or human resources applications, proprietary document retention repositories, and website access analytics engines, though other internal data sources are generally known in the art and may provide data to be retrieved as indicated at block 1801.

Method 1800 may continue at block 1802 with retrieving data from an external data source. As noted above, in this context, the concept of “external” is intended to be read broadly enough to mean a data source that is neither owned, operated, managed, maintained, leased, nor otherwise controlled by the same entity that owns and operates a processing system (such as system 499, for example) that executes method 1800. Examples of such external data sources noted above include third party financial institutions' computer systems or software output, third party merchants' point of sale data or other transactional databases, and third party website analytics and performance metrics data services. As with block 1801, any of various third parties may provide external data at block 1802, depending upon the application and overall desired functionality of method 1800. The present disclosure is not intended to be limited by the nature, amount, or characteristics of the internal data or external data retrieved at blocks 1801 and 1802.

Method 1800 may then continue with applying instruction sets or other code to process the data that were retrieved at blocks 1801 and 1802 (see block 1803). As set forth above and noted in FIG. 18, such data may be processed responsive to the retrieving operation and in accordance with the data source (e.g., internal or external) from which the data were retrieved; it is also noted that user input may also influence operations at block 1803, as noted above with reference to FIG. 4 and as is generally known in the art. In that regard, the processing operations depicted at block 1803 are intended to prepare retrieved data for selective display (for example, in a dashboard 100, 200, or 500) as determined by settings or preferences that are determined by a user as set forth above in connection with the discussions of FIGS. 1, 2, 5, and 17. In that regard, by way of example, a system 499 may employ a processing resource 399, either independently or in cooperation with various modules (such as are depicted at reference numerals 460, 493, 494, 495, 496, and 497 in FIG. 4) and a data store (reference numeral 410 in FIG. 4) having code and data sufficient to enable processing resource 399 to prepare a multi-functional dashboard 100, 200, 500, or 1700 for display. Additionally or alternatively, such a processing resource 399 may pre-process or partially process such data and provide interim results that enable a remote device to construct and display some or all of a multi-functional dashboard 100, 200, or 500.

If a determination is made (e.g., at decision block 1899) that additional data are to be retrieved from a particular data source or application, then the method may selectively loop back to block 1801 (dashed arrow 1897) or to block 1802 (dashed arrow 1898), depending upon whether the additional data stream is internal or external. In the event that no additional data are to be retrieved, the method may proceed to block 1804.

Results of the processing operation may be displayed as indicated at block 1804. As noted above, this may involve preparation, construction, layout, transmission, and subsequent representation of (or data representative of) a multi-functional dashboard user interface (such as depicted at 100, 200, and 500) on a screen or graphics display associated with a device (such as device 299) operated by a user (reference numeral 490). As is generally known in the art, such a multi-functional dashboard user interface may accept input from a user that may influence further processing (such as, for example, as illustrated at block 1803).

A data source (irrespective of whether that data source is internal or external) may be instructed to update one or more data records responsive to the processing operation at block 1803, input from a user or operator, or both, as indicated at block 1805. By way of example, system 499, in general, or processing resource 399, in particular, may so instruct a third party system or software application, or an in-house system or software application, that is independent of system 499 responsible for executing method 1800 to update, alter, or otherwise manipulate a data record, for example, via dedicated APIs such as are depicted in FIG. 4. Examples of such an update include a user modifying bank account information (e.g., via banking module 460), updating, adding, or deleting employee records (e.g., via payroll processing module 495), associating a bank account with a payment function for a loan (e.g., via loan module 493), and the like. In that regard, a multi-functional dashboard user interface system and method as illustrated and described herein are intended to be bi-directional, i.e., configured and operative to accept and to employ input from a user, not just to present information to a user from disparate sources.

The arrangement of the blocks and the order of operations depicted in FIG. 18 are not intended to exclude other alternatives or options. For example, it will be appreciated that in accordance with one implementation, the operations depicted at blocks 1801 and 1802 may be executed substantially simultaneously, or may be integrated into a single operation; they may also be reversed. As another example, the operation depicted at block 1803 may be executed concomitantly with the operations at block 1801, 1802, or both, where computational resources are capable of real-time or near real-time operations as a function of execution requirements, for example, which may be determined by the sophistication of the bit stream, the computational bandwidth of processing resource 399, or a combination of these and other factors. In some implementations, the decision block 1899 may precede the processing operations at block 1803. Further, those of skill in the art will appreciate that the operations depicted at blocks 1804 and 1805 may occur substantially simultaneously, or may even be reversed, as a third party or other external data source may be updated while or before results of processing are displayed (such as on a dashboard 100, 200, or 500).

These and other such alternatives may readily be effectuated without materially impacting results provided by, or the functionality of any particular hardware implementation utilized to execute, method 1800. In addition to the alternatives set forth above, various design choices that may influence the order or arrangement of the operations depicted in FIG. 18 will be apparent to those of skill in the art and are within the scope of the disclosed subject matter.

Several features and aspects of a system and method have been illustrated and described in detail with reference to particular embodiments by way of example only, and not by way of limitation. It is noted again that alternative implementations and various modifications to the disclosed embodiments are within the scope and contemplation of the present disclosure.

What is claimed is:

1. A method of displaying records using a multi-functional dashboard user interface of an enterprise, said method comprising:
retrieving data from a plurality of sources;
responsive to said retrieving data, ingesting and processing the retrieved data by applying a plurality of source-specific instruction sets to selectively process the data in accordance with each respective data source to aggregate and prepare the data for selective display on the multi-functional dashboard user interface;
displaying a result of said processing in the multi-functional dashboard user interface that includes a plurality of user-configurable data zones, each data zone including a user-configurable arrangement of a plurality of user-configurable displays, with a first one of the user-configurable displays selectively displaying information in an aggregated presentation form from the plurality of data sources; and
providing a user-customization interface that facilitates selective customization, including programming, grouping, re-arrangement, and/or variation of size and orientation, of the user-configurable data zones, wherein the user-configurable data zones are selectively customizable before the multi-functional dashboard user interface is configured to access any one or more of the data sources.

2. The method of claim 1, wherein retrieving the data from the plurality of sources includes :
retrieving internal data from an internal enterprise data source that is owned, maintained, and controlled by an enterprise which is an operator of the multi-functional dashboard user interface; and
retrieving external data from a plurality of disparate external data sources that are owned, maintained, and controlled by at least one entity other than the operator of the multi-functional dashboard user interface.

3. The method of claim 1, further comprising:
selectively instructing a certain one of the plurality of data sources to update a data record of that certain data source responsive to said processing and, optionally, responsive to input from a user.

4. The method of claim 1, wherein retrieving data from a plurality of sources includes accessing respective application programming interfaces of each of the plurality of data sources using source-specific interfacing instructions.

5. The method of claim 1, further comprising:
storing user-selected documents from the plurality of data sources in an aggregated document repository and displaying at least a portion of a listing of the stored documents in a corresponding data zone.

6. The method of claim 1 wherein said displaying comprises transmitting the dashboard user interface to a display associated with a user device.

7. The method of claim 1 wherein said displaying comprises transmitting data associated with the dashboard user interface to a display associated with a user device.

8. The method of claim 1 wherein said selectively instructing comprises causing a system associated with the internal data source or the external data source to alter the data record based upon the user’s interaction with the dashboard user interface.

9. A multi-functional dashboard user interface system of an enterprise, the system comprising:
a computer system that includes processing hardware configured and operative to:
receive and ingest first data from a plurality of data sources that include a first data source and a second data source;
apply source-specific instruction sets to selectively to process first data from the first data source and second data from the second data source, respectively, to aggregate and prepare the ingested data for selective display on the multi-functional dashboard user interface;
provide an output to a display for displaying a multi-functional dashboard user interface that includes a plurality of user-configurable data zones, each data zone including a user-configurable arrangement of a plurality of user-configurable displays, with a first one of the user-configurable displays selectively displaying information in an aggregated presentation form from a plurality of data sources, wherein the user-configurable data zones are selectively alterable, re-arrangeable, and manipulable via a user-customization interface; and
provide the user-customization interface that facilitates selective customization, including programming, grouping, re-arrangement, and/or variation of size and orientation, of the user-configurable data zones, wherein the user-configurable data zones are selectively customizable before the multi-functional dashboard user interface is configured to access any of the internal and external data sources.

10. The system of claim 9 wherein the processing hardware is further configured and operative to:
selectively instruct a certain one of the internal data source or the external data source to update a data record of that certain data source responsive to said processing and, optionally, responsive to input from a user.

11. The system of claim 9, wherein the computer system is further operative to store user-selected documents from the internal and the external data sources in an aggregated document repository and providing an output to a display for displaying at least a portion of a listing of the stored documents in a corresponding data zone.

12. The system of claim 9 wherein said processing hardware comprises a central processing unit.

13. The system of claim 9 wherein said first data source processing module receives the first data via a first application programming interface.

14. The system of claim 13 wherein said second data source processing module receives the second data via a second application programming interface distinct from the first application programming interface.

15. At least one non-transitory machine-readable storage medium containing instructions that, when executed by a computer system, cause the computer system to implement a process of displaying records using a multi-functional dashboard user interface of an enterprise, the process comprising:
retrieving data from a plurality of sources;
responsive to said retrieving data, ingesting and processing the retrieved data by applying a plurality of source-specific instruction sets to selectively process the data in accordance with each respective data source to aggregate and prepare the data for selective display on the multi-functional dashboard user interface;
displaying a result of said processing in the multi-functional dashboard user interface that includes a plurality of user-configurable data zones, each data zone including a user-configurable arrangement of a plurality of user-configurable displays, with a first one of the user-configurable displays selectively displaying information in an aggregated presentation form from the plurality of data sources; and
providing a user-customization interface that facilitates selective customization, including programming, grouping, re-arrangement, and/or variation of size and orientation, of the user-configurable data zones, wherein the user-configurable data zones are selectively customizable before the multi-functional dashboard user interface is configured to access any one or more of the data sources.

16. The least one non-transitory machine-readable storage medium of claim 15, wherein in the process, retrieving the data from the plurality of sources includes:
retrieving internal data from an internal enterprise data source that is owned, maintained, and controlled by an enterprise which is an operator of the multi-functional dashboard user interface; and
retrieving external data from a plurality of disparate external data sources that are owned, maintained, and controlled by at least one entity other than the operator of the multi-functional dashboard user interface.

17. The least one non-transitory machine-readable storage medium of claim 15, wherein the process further comprises:
selectively instructing a certain one of the plurality of data sources to update a data record of that certain data source responsive to said processing and, optionally, responsive to input from a user.

18. The least one non-transitory machine-readable storage medium of claim 15, wherein in the process, retrieving data from a plurality of sources includes accessing respective application programming interfaces of each of the plurality of data sources using source-specific interfacing instructions.

19. The least one non-transitory machine-readable storage medium of claim 15, wherein the process further comprises:
storing user-selected documents from the plurality of data sources in an aggregated document repository and displaying at least a portion of a listing of the stored documents in a corresponding data zone.

20. The least one non-transitory machine-readable storage medium of claim 15, wherein in the process, selectively instructing comprises causing a system associated with the internal data source or the external data source to alter the data record based upon the user’s interaction with the dashboard user interface.
